(19) United States
(12) Patent Application Publication
(10) Pub. No.: US 2026/0284904 A1
(43) Pub. Date: Sep. 24, 2026

(54) TAPE SPRING MECHANISMS AND METHODS FOR DEPLOYABLE MANIPULATION

(71) Applicant: The Regents of the University of California, Oakland, CA (US)

(72) Inventors: Nicholas Gravish, La Jolla, CA (US); Gengzhi He, La Jolla, CA (US); Curtis Sparks, La Jolla, CA (US); Hangjun Liu, La Jolla, CA (US)

(21) Appl. No.: 19/571,341

(22) Filed: Mar. 18, 2026

Related U.S. Application Data
(60) Provisional application No. 63/774,679, filed on Mar. 19, 2025.

(51) Int. Cl. B25J 15/00

(52) U.S. Cl. CPC B25J 15/0004

(57) ABSTRACT

Devices, systems, and methods for grasping and manipulating objects are described. One example gripper device includes two or more tape spring structures, each tape spring structure comprising at least one tape spring, wherein the tape spring structures each have at least one fold region where the tape spring structure is folded back on itself, and a plurality of drive actuators coupled the two or more tape spring structures and configured to drive the tape spring structures such that a location of the fold region associated with each tape spring structure changes along a length of the tape spring structure or in space, wherein the two or more tape spring structures are spaced apart from one another other to allow an object to be grasped therebetween, and wherein driving of the two or more tape spring structures enables a rotation or a translation of the object while the object remains grasped.

### CROSS-REFERENCE TO RELATED APPLICATIONS

This patent document claims priority to and benefits of U.S. Provisional Patent Application No. 63/774,679 entitled “TAPE SPRING MECHANISMS FOR DEPLOYABLE MANIPULATION” filed on Mar. 19, 2025. The entire content of the aforementioned patent application is incorporated by reference as part of the disclosure of this patent document.

### STATEMENT REGARDING FEDERALLY SPONSORED RESEARCH

This invention was made with government support under 1935324 awarded by the National Science Foundation. The government has certain rights in the invention.

### TECHNICAL FIELD

The technology described in this patent document relates to devices, systems, and methods for grasping and manipulating objects.

### BACKGROUND

Robotic manipulators with large reach and small storage volume have substantial potential for operation in remote environments such as space and the deep sea. However, striking a balance between a large manipulation workspace and small storage volume poses a challenging design problem. Traditional rigid-link-based robot arms are fundamentally limited since their physical volume does not change during operation. To circumvent this tradeoff between reach and volume, engineers have looked to deployable structures which can expand dramatically in volume from compact to extended states. However, current deployable manipulators face many limitations such as the volume changing body and the end-effector being typically separate entities. The end effector thus adds substantial weight to the system and requires cabling to be routed through the deployed structure. Additionally, since gripping can only occur at one location (the end effector itself) the whole system lacks reconfigurability.

### SUMMARY

Disclosed are robotic manipulator devices, systems and associated methods that use tape springs as both extendable arms and gripping surfaces simultaneously. Similarly to a tape measure, tape springs can be coiled for compact storage and then uncoiled to reach long distances. The tape springs can bend and twist to manipulate and grasp objects. Rather than serving as a support mechanism for deploying an end-effector (e.g., claw, hand, etc.), the tape springs themselves can be used to interact with objects, so they can be used to pick up and turn items, unscrew objects, or move them around in a conveyor belt fashion. These manipulators may be used for mobile robotics or industrial applications where objects need to be moved in a confined environment. Additionally, these manipulators are able to pick up multiple delicate and/or irregularly shaped items, which is a task that remains challenging for traditional robotic hands.

The disclosed technology can be implemented in some embodiments to provide a new mechanism for mobile and long-range manipulation of delicate objects. In some embodiments, a robot manipulator includes two or more tape springs laminated or otherwise coupled together. In some embodiments, two tape springs may be coupled together such that their curvatures point in opposite directions, providing a “bidirectional” tape. In other embodiments, two or more tape springs may be laminated or otherwise coupled together such that their curvatures point in the same direction to provide a multi-layered “unidirectional” tape. Tape spring appendages can be reversibly rolled and unrolled from a spool and extended over a long distance. Tape spring appendages may also be provided in the form of a loop, wherein the two ends of a tape spring are joined together. The disclosed tape spring appendages can grasp, convey, roll and generally rotate the objects in three dimensions without causing damage to the objects.

The disclosed technology can be implemented in some embodiments to provide two or more spools of bidirectional tape-springs that form two or more digits of a manipulation appendage. For example, a set of appendages can reach out in a plane and can grasp onto an object through a pinching motion. Once an object is pinched it can be pulled back towards the robot base through retraction (shortening the distance that the tapes are extended from the robot base), and/or conveying (translating the tapes through a spooling mechanism while leaving the appendages extended at the same distance). The tapes contact objects with low stiffness so that they can grasp delicate objects such as fruits or vegetables. Tapes may be modified with an external layer that, among other benefits, enhances the friction between the tape surface and the target object. Additionally, tapes may be modified with a compliant external layer or exoskeleton that enables them to conform to the shape of the target object.

### BRIEF DESCRIPTION OF THE DRAWINGS

FIG. 1 shows a photograph of an example tape spring two-digit manipulator on a robotic arm grasping and manipulating a pepper.

FIGS. 2A-2D show photographs and illustrations of example features and capabilities of tape spring-based manipulators.

FIG. 3A shows an illustration of the structure of a bidirectional tape.

FIG. 3B shows a data plot of the results of 3-point bend tests of different tapes.

FIG. 3C shows a data plot of the results of 4000 cycles of a fatigue test.

FIG. 3D shows a data plot of buckling force Fₘₐₓ of different tape springs at different lengths.

FIGS. 3E and 3F show data plots of the maximum force before buckling and angle at which the tape spring buckles, respectively, over 4000 trials.

FIG. 4 shows a photograph of an example planer test platform for an example two-digit manipulator system.

FIG. 5A shows a schematic illustration of GRIP-tape.

FIG. 5B shows schematics of example modes of appendage control in GRIP-tape.

FIGS. 5C and 5D show schematics of example control mechanisms for tape spring appendages.

FIG. 6A shows a schematic of the workspace of an example left appendage.

FIG. 6B shows an image of the combined workspace of two appendages overlaid with a data plot of the maximum gripping force at each point.

FIG. 7 shows the position error of the right digit tip location from six trials for 16 target points.

FIGS. 8A-8D show results from right digit tip location tracing over three trials with four different shapes.

FIGS. 9A-9E show photographs of an example of GRIP-tape performing soft gripping and twisting.

FIGS. 10A-10D show photographs of an example GRIP-tape used in a conveyance mode.

FIGS. 11A-11F show an example GRIP-tape grasping a lemon and placing it in a container.

FIG. 12A shows a photograph of an example GRIP-tape appendage with a load cell.

FIG. 12B shows a diagram depicting the balance of moment for a GRIP-tape appendage and load cell.

FIG. 12C shows a data plot of the comparison between the real force on the tip of the appendage measured by the additional load cell and the predicted value.

FIGS. 13A-13E and 14A-14E show photographs of an example of GRIP-tape performing object manipulation using force feedback.

FIGS. 15A-15D, 16A-16D, 17A-17D, and 18A-18D show photographs of GRIP-tape used as an end effector for a robot arm performing grabbing and reaching tasks.

FIG. 19 shows a photograph of an example looped tape spring gripper.

FIGS. 20A-20D show schematics illustrating various features and capabilities of the looped tape gripper shown in FIG. 19.

FIGS. 21A-21C show cross-sectional slices of the looped tape gripper exoskeleton.

FIGS. 21D and 21E show the overall shape of the example exoskeleton.

FIGS. 22A and 22B show photographs of a pressing experiment on example tape springs.

FIG. 22C shows a data plot of the displacement versus load curves of the tape springs with and without exoskeletons.

FIGS. 23A-23E show photographs and data plots of the measurement of the longitudinal and transversal pulling forces for example grippers.

FIGS. 24A-24E, 25A-25E, and 26A-26E show photographs of an example looped tape gripper grasping and manipulating various objects.

FIGS. 27A-27D show a series of photographs of an example gripper recovering following a collision with an obstacle.

FIGS. 28A-28D show a series of photographs in which an example gripper is used to pick up a cloth napkin.

FIGS. 29A-29D show a series of photographs of an example gripper picking up a cucumber and depositing it in a box.

FIGS. 30A-30F show photographs of an example gripper performing a task.

### DETAILED DESCRIPTION

A typical robot arm faces a tradeoff between the maximum distance it can reach (extensibility), and how compactly it can be configured. In some implementations, soft and stiffness-changing mechanisms can enable new modalities of robot appendages. The disclosed technology can be implemented in some embodiments to introduce a robot appendage design that enables high extensibility and novel grasping capabilities. In some embodiments, this manipulator is capable of grasping and rolling objects in-planar (GRIP) configurations and may be referred to as GRIP-tape. In some embodiments, the GRIP-tape appendages are constructed from a laminated bidirectional tape-spring structure which provides high lateral and compressive stiffness in the stiff state, and easy reconfiguration of revolute joints along the tape length.

Soft-materials for robotics may enable a multitude of new manipulation and locomotion capabilities. Compliance enables body adaptation to the environment during locomotion, responsive shape change for grasping complex objects, and inherent safety when interacting with or around humans. However, current soft robots often rely on fixed-shape bodies that are fluidically actuated and thus can limit the overall reach, or mobile capabilities of these systems. The disclosed technology can be implemented in some embodiments to provide a novel manipulation system which is capable of expanding from a compact-elongated state and manipulating objects through bimanual grasping. The disclosed technology can be implemented in some embodiments to provide compliant structures that can change in length, shape, and position, thereby significantly improving robot appendages and enable new forms of mobility and manipulation.

The disclosed technology can be implemented in some embodiments to provide a gripper that includes tape springs enabling grasping and rolling in-plane manipulation in a robot manipulator referred to as GRIP-tape. We developed bidirectional tape spring “fingers” that have large buckling strength compared to single tape springs, and which can be spooled into a compact state or unspooled to manipulate objects. The softness inherent to tape springs ensures the extensibility of the gripper fingers and imparts a springy touch at the tips of the appendage, enhancing its ability to interact with objects delicately. The stiffness of the thin shell structure that resists bending exhibited by the extended tape springs plays a pivotal role in the gripper's performance as the stiffness enables the gripper to bear the gripping force, thereby ensuring its capability to grasp and manipulate objects effectively. The capacity for smooth reconfiguration allows it to move with ease across a 2-D plane. By harnessing these characteristics of tape springs, the gripper design based on some embodiments of the disclosed technology may exhibit a unique combination of extensibility and stiffness, making it a promising solution for applications requiring dexterous manipulation, and the ability to handle objects from a longer distance

### INTRODUCTION

Some of the earliest deployable manipulators can be traced back to the kinematic mechanisms of the industrial age and before. For example, the scissor mechanism may be the simplest example of a linkage system that can dramatically increase in length through actuation of a single degree of freedom. Roboticists have leveraged expandable linkages such as the scissor mechanism to create deployable robot arms with gripping end effectors. Similarly, concentric tube telescoping structures have also been used to expand robot arms prismatically from a collapsed state. While scissor and telescoping mechanisms are limited to prismatic motion, more complex planar or spatial linkage arrangements can yield other three-dimensional modes of expansion. Additionally, kinematic expansion need not be limited to mechanical linkages. For example, sheets of folded paper using origami designs can also be deployed from flattened states to form elongated structures. Origami mechanisms can often be treated similarly to linkage systems, while they present new opportunities for fabrication, control, and stiffness modulation. Deployable linkage systems are predominantly made from rigid structures and thus they have the benefit of predictable kinematics. However, linkage-based deployable manipulators suffer from the same limitation as traditional robot arms: their physical volume never changes and thus they require careful design to pack the structure into a small volume when the manipulator is not deployed. To circumvent this limitation, recent advances in deployable robotics have leveraged soft materials which enable volume change through the system's elasticity or flexibility.

Soft robots using compliant materials enable adaptation to the environment during locomotion, responsive shape change for grasping complex objects, and inherent safety when interacting with or around humans. A recent design paradigm to make deployable mechanisms in soft robotics is engineered length and volume change of the robot body for robots that “grow.” Volumetric growth has been developed in systems such as pneumatic actuators, robot skins that enable body eversion, flexible zipping structures, or additive manufacturing technology. Growing robots have thus far shown great promise in deploying over extremely long lengths, moving through challenging substrates such as sand or the body for medical procedures, and relying on simple off-the-shelf materials. While soft growing robots are capable of more volume expansion compared to linkage-based mechanisms, they still suffer from the challenge that they must carry a separate end-effector for manipulation. This limitation makes cable routing through the expanding body a challenge for soft bodied deployable robots.

Similarly, early soft robotic grippers used silicone-based digits that were actuated hydraulically or pneumatically. These grippers provided adaptive grasping capabilities, similar to those of under actuated designs, and benefited from the lightweight, softness, and the flexibility of the structure that allows safe interaction between the mechanism and its surroundings. However, the inherent softness of these early soft robotic grippers and their hydraulic/pneumatic actuation design limited their gripping strength and led to slower reaction and actuation.

Another category of deployable manipulators is those that use a change in material curvature to collapse/expand and to modulate stiffness. Tubular deployable structures which can be flattened and rolled into a tight coil and extended into a strong linear beam are the most common form of these systems. In the flattened state the structure is relatively flexible to bending, however when the cross-section is expanded to a circle (or arc) substantial strength is provided by the bending resistance of curved materials. Tubular mechanisms often are fabricated from composite material such as carbon fiber, or metals such as steel. These mechanisms have been used as deployable beams and reconfigurable truss systems for robotic applications.

An exciting recent area of development for deployable manipulation is the use of tape spring-based mechanisms for robotic arms. Tape springs are a special example of a tubular structure that can be easily collapsed flat, exhibit bistable buckling behavior which can be used for energy storage/release, and have anisotropic stiffness for passive compliance. Materials suitable for use in tape springs include thin sheets of metals, such as steel, aluminum, copper, or nickel, or fiber-reinforced composites (e.g., carbon fiber composites). Some robots incorporate tape spring appendages with claw and/or adhesive end effectors to grasp onto cave walls, or to create truss structures and manipulators. Furthermore, robot arms that use two antagonistic tape springs can form local bends to place grasping anchors in challenging to reach locations. The curvature-dependent compliance of tape springs enables joint-link configurations to be reconfigured in robot arms by pinching locations to locally flatten the curvature. Lastly, small scale tape springs are being developed for steering needles through tissue. A common design paradigm of these robots is the use of tape springs as a structural element of the robot, whereas environment manipulation occurs through special end effectors.

Disclosed are devices, systems, and methods for deployable manipulation using tape springs in which the deployable tape spring structure also functions as the manipulator surface. With two or more appendages the manipulator robot is capable of object grasping and rolling in planar configurations. In some embodiments, this robot is referred to as GRIP-tape.

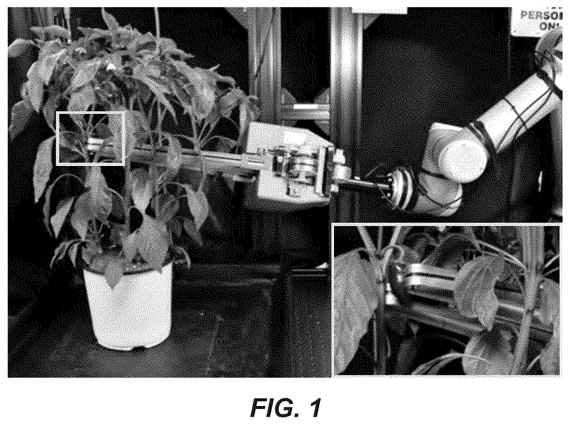

FIG. 1 shows a photograph of an example embodiment of a two-digit manipulator on a robotic arm grasping and manipulating a pepper. Differently from conventional robotic arms, the length of the tape spring may be used as a gripping surface which makes the arms lightweight (no extra motors or mechanisms needed at the end), reduces or eliminates any cabling requirements for an end effector, and enables versatile manipulation kinematics such as multi-object conveyance and rotation. Tape spring appendages may be optionally connected to a robotic arm, which can be used to move the appendages into a position suitable for object manipulation. The robotic arm and tape spring appendages may be controlled by a human operator and/or may operate autonomously, as will be described below.

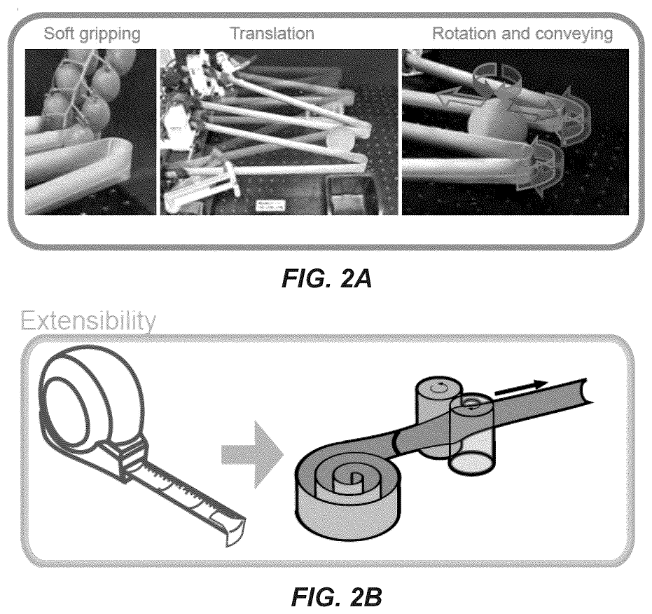

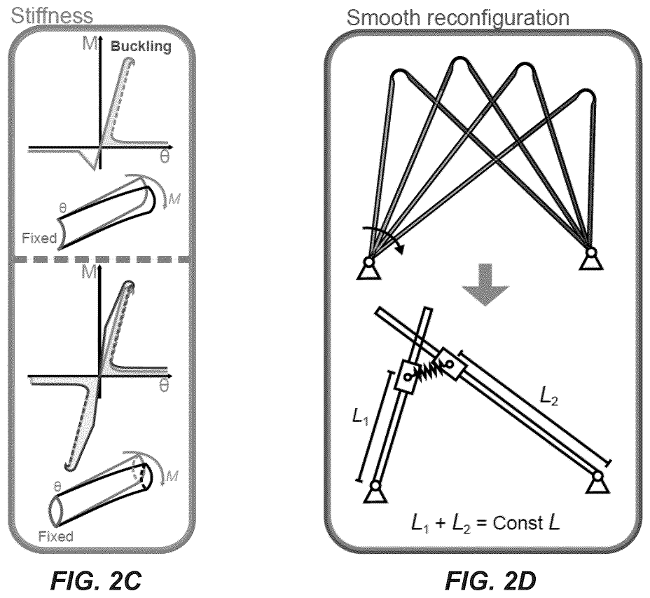

FIG. 2A shows photographs of an example two-digit tape spring manipulator performing various grasping and manipulation movements. Capabilities of the tape spring gripper include the ability to interact with soft objects, translate objects over large distances in a 2D plane, and manipulate objects in-grasp, including rolling and conveying objects.

FIG. 2B shows a schematic comparison of a conventional tape measurer and a tape spring used in some embodiments of the disclosed systems and devices. Tape spring beams are capable of being rolled into compact spaces and extended over long-distances. In some embodiments, tape spring manipulators may be deployed using one or more rollers controlled by a motor.

FIG. 2C shows a schematic comparison of stiffness in unidirectional (top) versus bidirectional (bottom) tape springs. The beam stiffness is asymmetric in the case of unidirectional tape springs, and symmetric in bidirectional tape springs. By developing laminated bidirectional tape springs, GRIP-tape has isotropic bending stiffness in the straight state, whereas in the bent state the tape springs provide high compliance enabling reconfiguration and the ability to interact with delicate objects.

FIG. 2D shows a schematic of movement and reconfiguration in an example tape spring appendage. By bending the tape spring back on itself, a reconfigurable appendage is formed. At the bend point, also referred to as a fold region, the curvature of the tape spring is locally flattened. The orientation of the appendage can be manipulated by adjusting the lengths and/or angles of the sides of the appendage, thus changing the location of the flattened point along the tape spring and in space. The kinematics of this appendage can be modeled as two rotation-prismatic joints coupled through an elastic spring.

### Example Designs for Bidirectional Tape Spring Appendages

The GRIP-tape robot uses the mechanical properties of curved beams for gripping stiffness and smooth hinge reconfiguration (as illustrated in FIGS. 2C and 2D). To design an example two-digit tape spring gripper, we first sought to analyze the mechanical performance of tape springs to validate that sufficient gripping force could be supported by deployed tape appendages.

A single tape spring, like that found in a tape measure, is relatively stiff when loaded by a transverse force pointing into the concave direction of the tape curvature. However, when loaded into the direction of curvature, or with torsional moments along the longitudinal axis of the tape, a single tape spring will quickly bend and not be capable of supporting load. To avoid the anisotropic buckling associated with transverse loading or the twisting failure from torsional loading, we sought to make a symmetric tape spring structure by binding two tape springs together along their length. This “bidirectional” tape design enables the tapes to spool into a compact shape for deployable applications while still retaining the stiffness required for gripping applications.

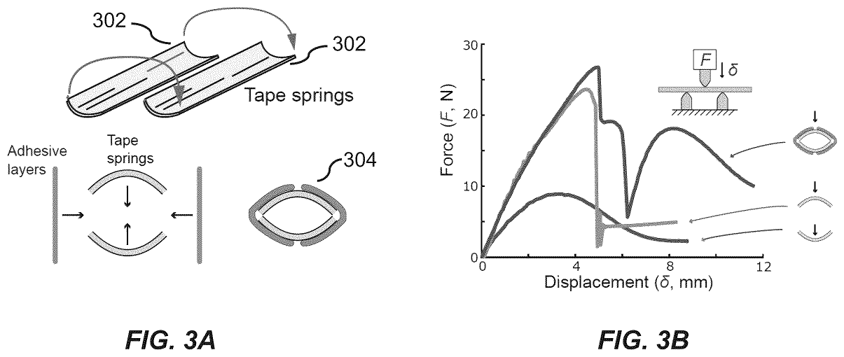

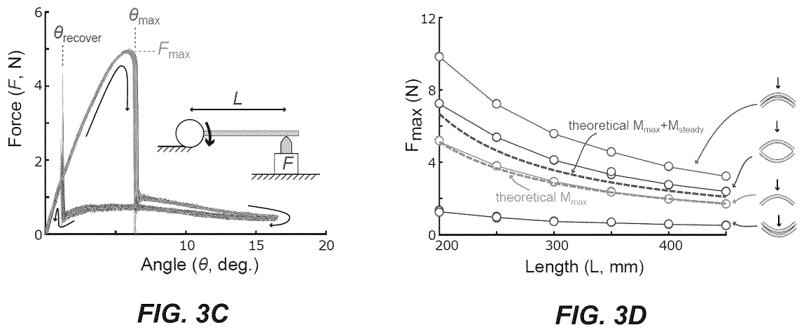

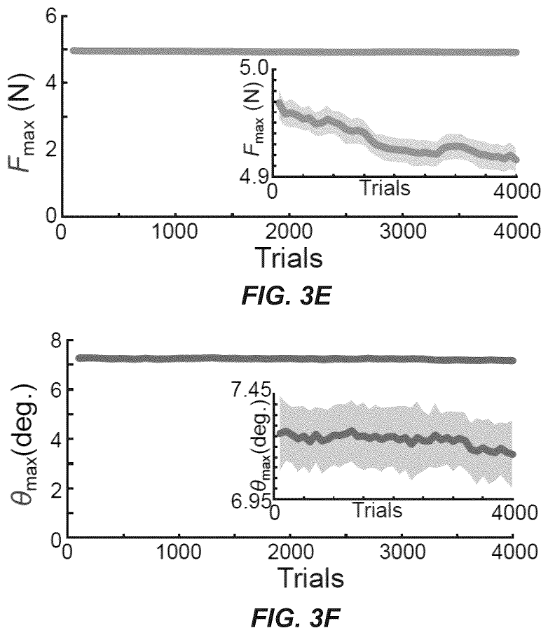

FIG. 3A shows an example illustration of the structure of bidirectional tape. In this example, we fabricated bidirectional tape springs for GRIP-tape by first aligning two spring-steel tape springs 302 collected from an off the shelf tape measure along their lengths. Next, we applied an adhesive layer (e.g., duct tape) along the sides of the two tapes to adhere them together to form the bidirectional tape 304, which has an elongate hollow structure. When the tape spring structure is folded back on itself, the bidirectional tape becomes locally flattened in the fold region. We note that the outer material used to bind the tape springs may be selected to modify the friction between the tape spring surfaces and a target object. Additionally, the binding material may be selected such that it maintains the alignment of the tape springs while still allowing them to slide relative to one another.

FIG. 3B shows a data plot of the results of 3-point bend tests of different tapes. To compare the strength performance of the bidirectional tape with single tape springs, we conducted a 3-point bending test. The results reveal that compared with the 2 configurations of unidirectional tape (shown schematically in FIG. 3B), the bidirectional tape exhibits the highest buckling force, indicated by the load peak. In the case of the unidirectional tape loaded on the concave side and forming an equal-sense bend (the green line), the load-displacement curve is smooth instead of a drastic drop, implying the flatting of the curve is smooth rather than buckling at a force threshold. Due to the geometric relationship inherent in bidirectional tapes, the displacement can be viewed as the combined effect of two unidirectional tapes reacting to the same applied load. In tests involving the unidirectional tape loaded on either the convex (opposite-sense) or concave (equal-sense) sides, it is likely that friction between the test platform and the two edges of the tape due to the flattening of the curve hinders deformation, resulting in an undesired increase in the recorded load. While in the case of the bidirectional tape, the expansion happens between the two tapes simultaneously, and the contact surface and the test platform has almost no displacement, thus the friction is reduced.

We next measured the buckling force of tapes at various lengths to determine the grip force capabilities of extended tapes. Theoretical modeling of tape spring beams indicates that buckling will occur when a critical bending moment is reached (Mₘₐₓ), and thus the grasping force-ability of the beams should decrease inversely with length.

FIG. 3C shows a data plot of the results of 4000 cycles of a fatigue test. During the experiment, a tape spring beam was rotated at the base and the contact force was measured with an object at a prescribed distance from the base until the tape buckled. The load cell measured the maximum force that the tape springs exhibit before buckling.

FIG. 3D shows a data plot of buckling force Fₘₐₓ (data and fitted curves) of different tape springs with response to the distance between the fixed point and external force. We ran the test on 3 different configurations of double-layered tape springs: the bidirectional tape and double-stacked tape (two pieces of tape springs stacked in the same direction) loaded in each direction. Additionally, a unidirectional tape loaded on its stronger side is also included for comparison. Note that in this test the bidirectional tape was made with a different fabrication method that held the tapes together in a heat-sealed fabric sleeve instead of a duct tape layer. In this fabrication, the tapes are free to move relative to each other and do not have the added stiffness of the duct tape to avoid the influence of the duct tape layer. For each test, the load cell was placed at a distance L from the rotating base, and the tape was rotated into the load cell until it buckled. The peak buckling force was then recorded, and the experiment was repeated three times for each length tested.

The results shown in FIG. 3D indicate that the opposite-sense buckling force of the double-stacked tape is nearly twice that of the unidirectional tape. However, when unidirectional tapes are subjected to a load into the direction of curvature still only provide minimal force. The buckling performance of the bidirectional tape was also good in comparison to the unidirectional tape. Importantly this tape can support loads equally on both sides, offering a more versatile and reliable deployable structure for manipulation. Thus, while a stacked unidirectional tape is suitable for use in some tape spring appendage embodiments (including but not limited to the loop appendage embodiments discussed later), the rest of this section will describe embodiments using bidirectional tape springs.

To compare our experimental measurements with the theoretical predictions from thin-shell elasticity theory we implemented a buckling model. In the experiment, the tape does not buckle at its very end because the shape of the fastening holder restricts deformation at the end. Accounting for the offset of 75 mm in the buckling location, the theoretical buckling force vs. distance curve aligns closely with the experimental data (dashed curve, FIG. 3D).

For the bidirectional tape, the theory requires a slight modification since we do not know how much moment the equal-sense bending contributes during the buckling of bidirectional tapes. As a lower bound on this prediction, we treat the buckling moment as the sum of the opposite-sense buckling moment

$${M}_{+}^{max}$$

and the steady moment M* to represent the total moment. The steady moment M* represents the minimum value of equal-sense bending, meaning the actual contribution of equal-sense bending is certainly greater than this value. This slight underestimation of the moment contributes to the gap between the theoretical and experimental data (dashed curves and solid curves, FIG. 3D). Another possible source of this discrepancy is the sliding friction between the tapes as buckling occurs, which would increase the actual buckling force compared with theory. For the subsequent analysis of the maximum gripping force that can be applied at different tape lengths we rely on the theoretical curve as it establishes a conservative lower bound for gripping force.

An important feature of a gripper is the capability to durably operate over long periods of time. This is potentially problematic for soft robots and deployable systems where the structures of the robot will repeatedly undergo large deformation and strain. Specifically for the GRIP-tape robot it is important that the tape spring appendages roll and unroll over many cycles during operation without fatigue and not exhibit failure from errant collisions that cause them to buckle. To test the fatigue performance of our bidirectional laminated tape springs we performed a test to measure the buckling force and angle over repeated loading. Using the same setup as the buckling test, we mounted a load cell on a track 20 cm away from the starting point of the tape spring. During the rotation, the tape measure contacts the load cell, buckles, stops at 16.5 degrees and rotates back to the initial position. We gathered data for 4000 cycles from the load cell measuring the maximum forces before buckling (FIG. 3E), and the angle at which the tape spring buckles (FIG. 3F).

FIGS. 3E and 3F show data plots of the maximum force before buckling and angle at which the tape spring buckles, respectively, over 4000 trials (insets show a zoomed in view of the data). After 4000 trials, the buckling angle and buckling force decreased minimally. The buckling angle reduced from 1.28 degrees to 1.16 degrees and the buckling force reduced from 4.97N to 4.92N. In the size and force range of the example GRIP-tape embodiment used here, such an amount of variation is acceptable.

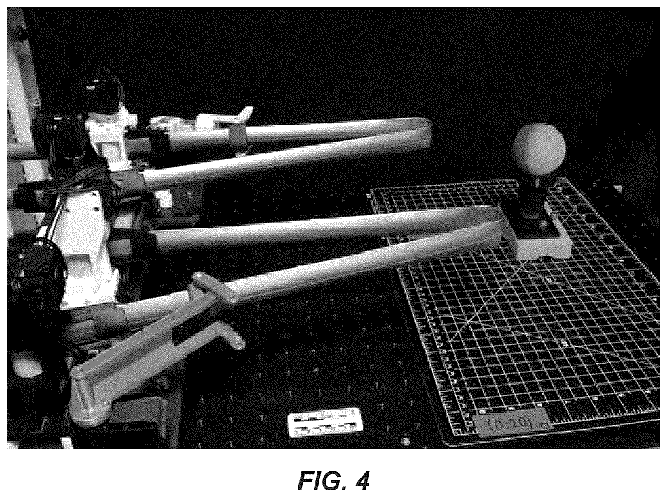

FIG. 4 shows a photograph of an example planer test platform for an example GRIP-tape system. In the example shown, GRIP-tape utilizes two appendages as the left and right gripping surfaces, each formed by bidirectional tape spring structures folded to form a triangular shape. Learning from the theoretical analysis, the performance of the gripper is influenced by the transversal curvature and the number of tape layers, which directly affect the buckling moment and tip stiffness. Increasing either thickness or curvature would increase the gripping force by improving stiffness and buckling resistance, however this would also reduce the flexibility of the tapes limiting their “safety” when inadvertently colliding with obstacles. For the examples described below, we selected a single-layer configuration for each side of the bidirectional tape, balancing stiffness and gripping force. Thus, the design incorporates an inherent safety feature, with the tape buckling at a specific load threshold to prevent excessive forces that could damage the gripper or the object.

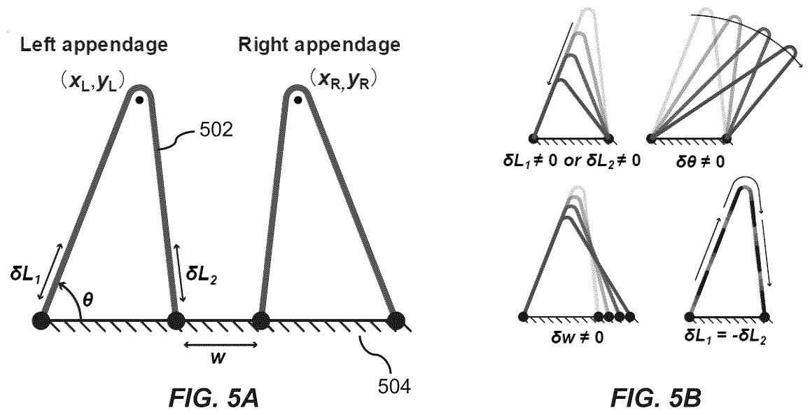

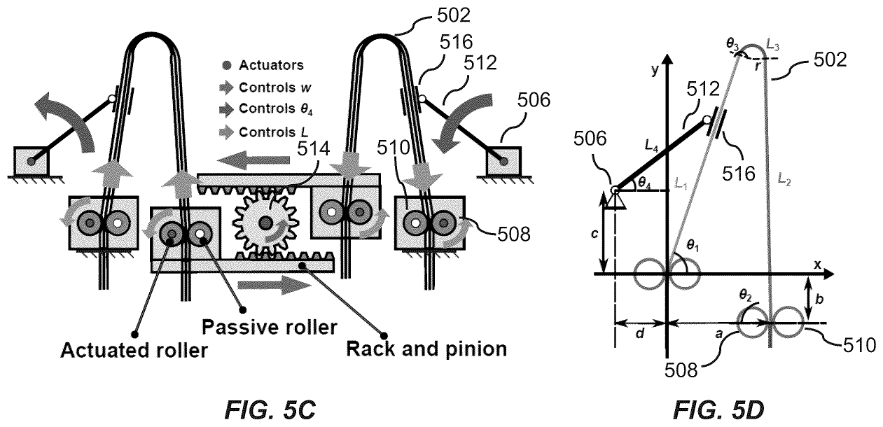

FIG. 5A shows a schematic view of an example of GRIP-tape, including the left and right digits 502, which extend from a base 504. Each digit has independent control over the tip location denoted by the black dots. The straight sections of the appendages act as structural elements that are capable of supporting transverse and compressive loads, whereas the buckled end of the appendage is a rolling hinge (also referred to as a fold region) that can change the overall shape of the appendage. The inner sides of the two appendages are the gripping surfaces and our design facilitates object grasping anywhere along the inner length of the appendages.

FIG. 5B shows schematics of example modes of appendage control in GRIP-tape. In some embodiments, each appendage has three independent control inputs: control of the outer beam angle (θ), and control of the length change from either the outer or inner side of the appendage (δL₁ and δL₂ respectively). The inner beam angle is free to rotate and is determined by the total tape length L and outer angle θ. Both left and right appendages have control over their respective beam angles and tape length change and thus can be controlled individually. Lastly, a single motor may control the symmetric gap width between the inner tapes w. The combination of three independent control inputs on the left and right appendage, and the width control yields seven overall control variables to position the tapes.

Individual actuation of the appendage control inputs leads to four example modes of appendage shape control (FIG. 5B). By changing the length of either the inner or outer section (δL₁≠0 or δL₂≠0) the outer beam will remain at angle θ while the overall tape length shortens causing the inner beam to bend. Note that the δL₁ and δL₂ actuators (also referred to as drive actuators) in this embodiment control the relative change in tape length, while the respective side lengths of the triangular shaped appendage are determined by the overall tape length and side angle θ. By changing the outer section angle θ the appendage traces a sweeping motion across the workspace. If the overall tape length is held constant, then the tip will trace out an elliptical shape. Changing the tape width w results in a change of the inner section angle and side length while the outer tape remains at a fixed angle θ. Lastly, an equal rate of tape unspooling and retraction on the inner and outer sections (δL₁=−δL₂) results in a conveyance motion where the overall shape of the appendage is unchanged, but the surface motion of the gripper will either move inwards or outwards.

FIG. 5C shows a schematic of example control inputs for the two tape spring appendages 502. In some embodiments, the GRIP-tape robot is actuated by a total of seven independent motors, as depicted in FIG. 5C. For each appendage, two motors 508 are dedicated to controlling the length change of the inner and outer tape spring beams, and one motor 506 controls the outer angle of each appendage by controlling the angle of an angular control beam 512. The last motor 514 is employed for adjusting the inner width between the appendages, w. In the example shown, this adjustment is achieved through a rack and pinion mechanism. Each tape extruder assembly includes two 3D-printed cases, each housing a pair of rollers. One of the rollers is driven by a servo motor 508 and is equipped with sandpaper to enhance friction, while the other roller 510 is passive and freely rotates. The rollers are pressed tightly together and the bidirectional tape is passed between them. In some embodiments, a drive actuator may include a motor 508 and a pair of rollers.

FIG. 5D shows a schematic of an example left-appendage with actuation inputs from two roller units (controlling θ₁, θ₂) that control the left-right length of the appendage, and a rotational input (θ₄) that controls the angle of the appendage. Additional supporting guides (omitted for clarity) m ay b e u se d to hold the tapes in position on both sides of the rollers. For the length of an appendage, both extruders (rollers controlled by motors 508) are capable of controlling the total length L, and the overall appendage's length (shape) is also influenced by the distance between the 2 extruders a and the orientation of the angular control beam 512 (θ₄) (FIG. 5D). The appendage's angular orientation is governed by a guiding ring 516 covered by low-friction material and an angular control beam 512 located on each appendage. The pivot axis of the angular control beam 512 is affixed to a servo motor 506 mounted on the base and so the outer mounting geometry of the appendages (lengths c and d in FIG. 5D) are predetermined and not adjustable in this example. Conversely, the triangle base-width (parameter a in FIG. 5D) for each appendage can be changed and thus is designed to facilitate the grip and conveyance of objects of varying sizes. Notably, because the racks are mounted parallel to the x-axis, parameter b is set and not adjustable in this example.

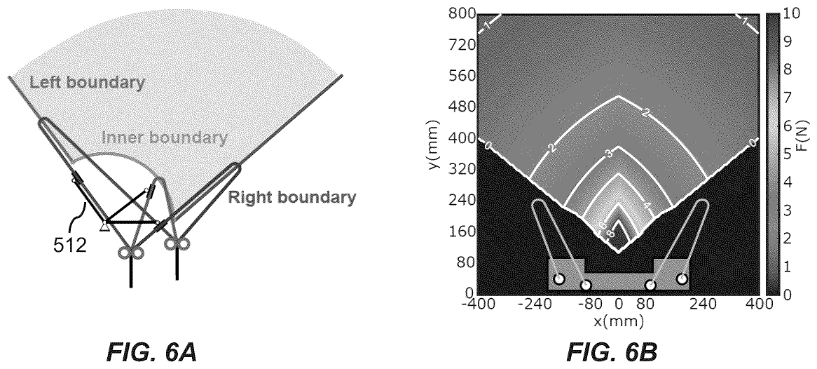

FIG. 6A shows a schematic of the workspace of an example left appendage. The total gripping workspace is determined by the combined range of motion of the appendages, each with an angle restricted annular reach. For the left appendage, the left angle boundary is constrained by the tape coming into contact with the pivot of the angular control beam 512. The right boundary is limited by the angular control beam colliding with the extruders. In the radial direction, the inner workspace radius is defined by the minimum allowable length of the appendage to ensure that the tip does not interfere with the angular control beam 512. The outer workspace radius is determined by the allowable extension distance of each tape structure before they buckle under their own weight. The right appendage workspace is the mirror of the left and the total workspace is the inclusive combination of the left and right appendages.

FIG. 6B shows an image of the combined workspace of both appendages with the maximum gripping force computed from buckling measurements indicated with a color map. The maximum gripping force was calculated by combining the data from the bend test with rotary stage and the workspace analysis. The calculation of the maximum gripping force involves the relationship between the maximum force resisting bending and the deployed length of the supporting side of the appendage (FIG. 3D). Besides bending, another potential failure mode is torsional bending under load. For instance, in horizontal gripping a heavy object could cause the inner sections of the appendage start to rotate torsionally downward. Our experiments indicate that the tape structures shown here are able to support larger weights at larger distances (i.e. larger torsional failure moments) than they are capable of generating gripping forces. This means that even if the friction coefficient between the object and the appendage is large, the torsional load the appendages can support is still greater than the weight that the maximum gripping force can hold. As a result, bending buckling becomes the dominant failure mode during grasping.

Although tape appendages are capable of interacting with objects along the lengths of their inner surfaces, due to the convenience of directly controlling the location of the appendage's fold region we use the minimum length of the appendage to calculate gripping force. This heat map reveals that the example GRIP-tape can support the highest gripping force near the base, particularly in the central region. As the distance from the base increases and the location moves laterally away from the central line (i.e. x=0 mm), the gripping force diminishes.

To derive the forward and inverse kinematics associated with the example two-digit gripper shown in FIGS. 5C and 5D, we assume an appendage is separated into 3 sections: 1-2) Two straight line sections L₁, L₂, and 3) a constant curvature arc of length L₃ representing the fold region that is tangent to both L₁ and L₂ (FIG. 5D). Although the deployed beams of tape still experience some deformation when load is applied, to simplify the model we assume they are rigid links. In our design, b, c, d, and L₄ are known and constant variables. Since r reflects the load on the appendage, in a scenario with almost 0 load, we use a constant r=15 mm which is determined from measurements.

By inputting (x, y) and a, the inverse kinematics solves for the length of each section L₁, L₂, L₃, and θ₄. The inverse kinematics purely involves a geometric calculation. The main steps of inverse kinematics involve determining lengths and angles of the supporting contact section L₁, L₂, θ₁, and θ₂ with the desired x, y position as the first steps. With the relationship θ₁−θ₃=−θ₂ and known variable r, the length of bending section L₃ is derived. Within the workspace, θ₄ can be bijectively mapped from θ₁.

The forward kinematics use inputs of total length L, arm angle θ₄, and the horizontal distance between the extruders a to solve for the location of the center of the fold region (x, y). The location of the outer extruder is set as the origin. The location of the guiding ring on the angle control arm relative to the origin is

$$v = [ \begin{matrix}- d \\ c\end{matrix} ] + {L}_{4} [ \begin{matrix}cos {θ}_{4} \\ sin {θ}_{4}\end{matrix} ] .$$

The appendage angle (θ₁) is determined by the unit vector of the guiding ring position \hat{v}=v/|v|. The center of the fold region can be found through a vector sum of the outer appendage arm and a perpendicular radius of the curve r;

$$X = {L}_{1} \hat{ν} + r [ \begin{matrix}0 & 1 \\ - 1 & 0\end{matrix} ] \hat{ν} .$$

The length of the outer appendage arm L₁ is found by solving 3 nonlinear constraint equations. Two equations come from the x and y vector sum of the two appendage arms and their perpendicular radius, as both arms of the appendage must meet at the center of the fold region. The final equation is the total length constraint, as the total length of the appendage L is known.

$$L = {L}_{1} + {L}_{2} + r ( {θ}_{1} - {θ}_{2} + π )$$

$${L}_{1} sin ( {θ}_{1} ) + r sin ( {θ}_{1} - \frac{π}{2} ) = {L}_{2} sin ( {θ}_{2} ) + r sin ( {θ}_{2} + \frac{π}{2} ) - b$$

$${L}_{1} cos ( {θ}_{1} ) + r cos ( {θ}_{1} - \frac{π}{2} ) = {L}_{2} cos ( {θ}_{2} ) + r cos ( {θ}_{2} + \frac{π}{2} ) + a$$

To validate the kinematics model of the GRIP-tape appendage we performed two experiments to monitor positioning accuracy and repeatability. In the first experiment we commanded the appendage to move to 16 target points in the workspace, repeating this over 6 trials.

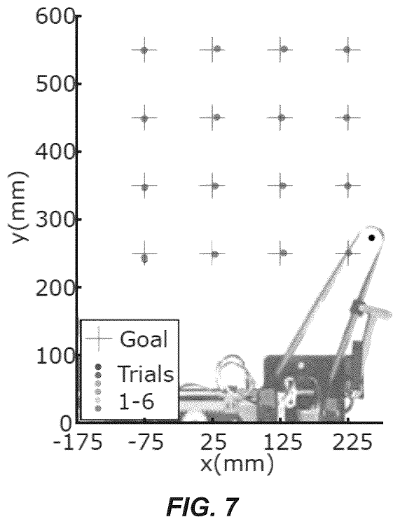

FIG. 7 shows the inverse kinematics position error of the right digit tip location of an example two digit gripper from six trials for 16 target points. Across the 6 trials for each of the 16 target points, the norm of the vector distance between the desired x-y location and the measured x-y location was determined to be an average position error of 3.72±0.35 mm. This means the mean absolute error of the 96 sample points in the plane is 3.723 mm. The mean of standard deviations of the error is 0.3548 mm. The mean was likely not centered at zero because of possible over-simplifications of the inverse kinematics model. These oversimplifications could include: imperfection in the fabrication of the tape and mechanism, inaccurate representation of the tape thickness, inaccurate assumption in the kinematic model, potential vertical sag of the tape, and deviations of the bend curvature due to internal stress from the tape. To demonstrate the motion control capabilities from the GRIP-tape kinematics we conducted a second set of experiments in which we moved the appendage tip along a variety of path shapes.

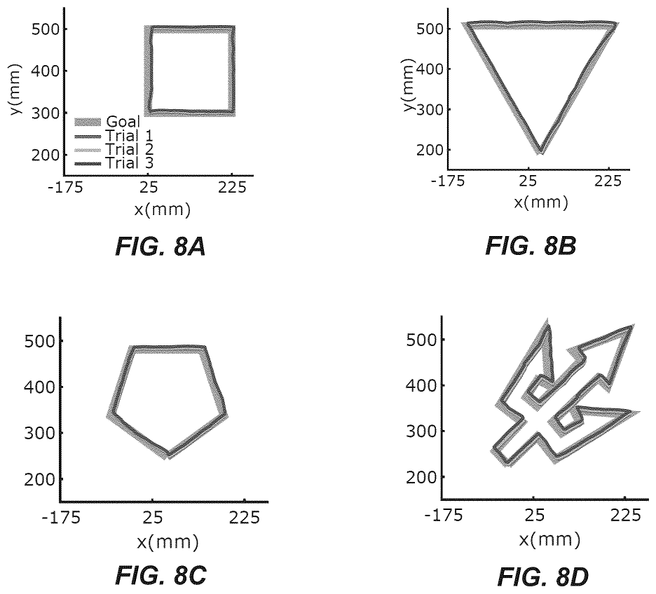

FIGS. 8A-8D show results from right digit tip location of an example two digit gripper tracing over three trials with four different shapes. Path following was tested through three cycles of path following across four polygonal shapes. The motion paths were repeated consecutively without any calibration between. We observed good tracking behavior between the desired and observed paths indicating that GRIP-tape is capable of suitable positioning control.

In each appendage of the GRIP-tape, two tape extruders adjust the length of the appendage. As described above, each extruder may include two rollers, where one is controlled by a motor and the other is passive. By extending or retracting tape with the extruders, the overall length and reach of the appendage can be changed. To determine how far an appendage can reach, the GRIP-tape was mounted horizontally and a tape appendage was extended parallel to the floor until it buckled under its own weight. This was done with both a unidirectional tape appendage and a bidirectional tape appendage. The longest successful extension of a unidirectional tape appendage reached was 1.07 m. Due to gravity, oscillation, imperfections in fabrication, and the anisotropy of the unidirectional tape; it buckles on itself and collapses. A bend is formed diagonally across the tape spring that causes the end of the appendage to hang down towards the floor. The bidirectional tape does not have the same anisotropy, so it performed significantly better. The bidirectional tape successfully extended to a max length of 1.52 m. Unlike the unidirectional tape, the bidirectional tape is limited primarily by weight and the stiffness of 3D printed parts used to control and guide the tapes in this example. In other embodiments, parts may be manufactured with different materials and/or methods. As the bidirectional appendage reached out farther, it began to sag under its own weight and caused bending in the base and extruder assembly as well.

To reach high extensions of the appendage while maintaining a small size, it may be necessary to store long lengths of the tape springs in a small volume. When used in a tape measure, tape springs are stored in a compact form by winding them on a spring-loaded spool. This can also be done for the unidirectional tape by wrapping both sides of the appendage tape around a spool on the opposite side of the extruders. However, this becomes more challenging in the case of bidirectional tapes. When the two tapes are adhered together directly with an adhesive wrapping (e.g., duct tape), they are unable to slide (shear) relative to each other. When the tape is wrapped around a spool, there is a mismatch in the length of material needed for the tape on the inside of the coil and the tape on the outside of the coil. This causes the bidirectional tape to form bumps and kinks as the length mismatch builds up. These imperfections prevent even coiling of the tape. To address this issue, in some embodiments two tapes may be bound together with a low-friction sleeve between the adhesive and the inner tapes. Since the adhesive is not directly attached to the tapes in this case, they can slide internally with respect to each other and prevent the problematic accumulation of shear strain along the tape length. By adding an external sleeve to the bidirectional tape fabrication process we are able to spool up the appendage tape and unroll it during deployment.

The structure of one appendage of the GRIP-tape can be represented kinematically as two prismatic links, with constant length constraint, that are connected by a nonlinear spring at the tip of the appendage, representing the fold region (as shown in FIG. 2D). As GRIP-tape interacts with an object the bend curvature at the end of the tape appendage undergoes changes corresponding to the change in gripping force. As the gripping force increases, the radius of curvature decreases, leading to a spring-like resistance. To quantify this resistance, different configurations of tape were bent 180 degrees, and the tapes were subjected to compression tests. The force readings during the compression of the tape were recorded as a function of displacement, enabling the measurement of the “stiffness” in the tape's contact mechanics. These results were compared with a theoretical curve derived by differentiating the strain energy U of the bending section, as given by:

$$U = \frac{Db ψ}{2} ( \frac{1}{r} + \frac{r}{{R}^{2}} - \frac{2 v}{R} )$$

with respect to the displacement d. The strain energy is minimized when r=R, indicating that the radius of curvature without applied pressure is R, leading to d=2(R−r). In this expression, ψ is the bending angle, which is 180 degrees in our case, and b is the tape's width, defined as θR.

By fitting the experimental data to a polynomial curve, we derived the experimental relationship between the applied load and the deformation of the spring-like bending. An observed discrepancy between the theoretical and experimental curves highlights the role of deformation in the transition region (the segment that connects the bent arc to the straight section). This deformation is not accounted for in the theoretical model. Based on our observations, assuming the length of the transition region remains constant during compression, the following phenomena occur. As the arc is compressed, the bending region shortens, while the straight region lengthens by the same amount. This redistribution reduces the potential energy associated with the lengthened straight region, thereby diminishing the overall energy gained during compression. Consequently, the experimental results indicate an effective material stiffness that is lower than the theoretical prediction.

As a means of comparison to other elastomeric soft grippers we envisioned that the tape spring bend joint is a 15 mm×25.4 mm×30 mm sized cube, and calculated an effective Young's modulus of this mechanism. Comparison of the approximate Young's modulus of the tape spring bend with other soft materials indicates that the contact interaction mechanics performance are broadly similar to silicone elastomers.

### Example Bidirectional Tape Spring Appendage Grasping Capabilities and Demonstrations

In the prior section we demonstrated the mechanics of deployable tapes and our ability to exert simple kinematic control over the appendages. We now illustrate some examples of the gripping capabilities of the two appendage GRIP-tape system.

Once both appendages of the GRIP-tape contact the target object with a sufficient load, a grasp is formed and we can translate the object by simultaneously moving the left and right appendages to different target positions. In our first demonstration we grasp a rubber ball at the tip of the appendages, translate the ball to a desired position, rotate the ball in place, and then convey the ball towards the gripper base and release it into a bin.

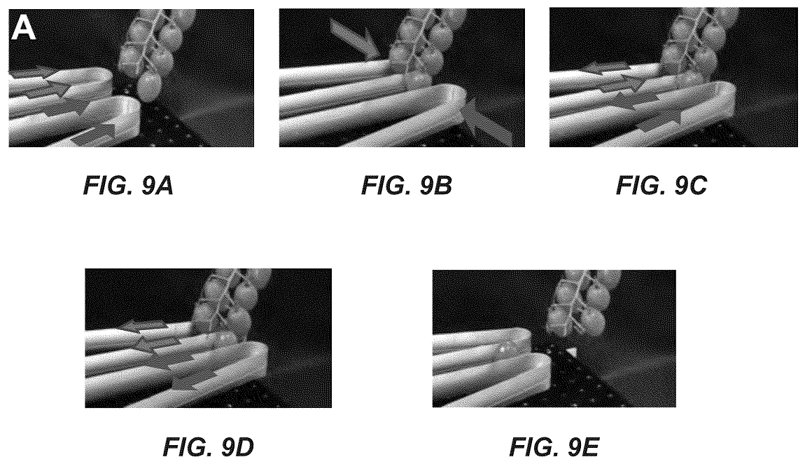

FIGS. 9A-9E show photographs of an example two-appendage embodiment performing soft gripping and twisting. The GRIP-tape is capable of grabbing objects of varied shapes and stiffnesses such as individual tomatoes and entire tomato vine.

In-place, continuous rotation is an important capability of the GRIP-tape kinematics. For example, GRIP-tape may be used to facilitate inspection of an object by a remote operator. Object rotation is achieved by displacing the object contact points in opposite directions. The overall length of the appendage can be kept constant during rotation by spooling and un-spooling the tape spring structures at the base of each appendage by the drive actuators. Thus, if we want to rotate a ball of a radius r by 90 degrees, the surface on the contact section of the tape of the left appendage has to extend πr/2. To keep the ball at a constant location, the contact section of the tape of the right appendage has to retract πr/2. Accordingly, the supporting section of the left appendage retracts πr/2, and the supporting section of the right appendage extends πr/2.

In-place rotation can be used to accomplish challenging picking operations such as twisting a tomato off of the vine (FIGS. 9A-9E). The soft-contact capabilities of the tape allow for applying light pressure to the tomato surface, and a continuous in-place rotation twists the tomato releasing it from the vine.

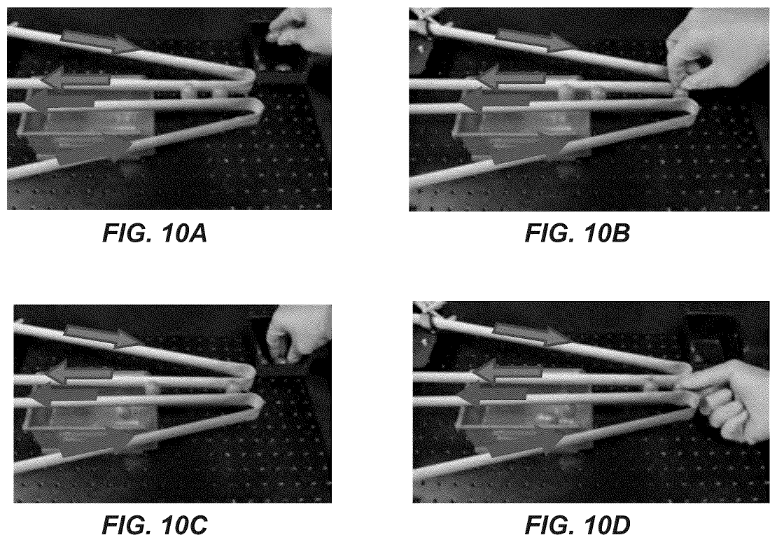

FIGS. 10A-10D show photographs of an example embodiment of GRIP-tape used in a conveyance mode. An additional function of GRIP-tape is the capability to convey objects inwards to the base while keeping the overall shape of the appendages constant. Object conveyance can even be extended to multi-object conveyance where several objects can be grasped and simultaneously translated back to the base of the gripper (e.g., the tomatoes in FIGS. 10A-10D).

FIGS. 11A-11F show a lifting example of grasping a fresh lemon from a distance of approximately 50 cm, vertically lifting the lemon and orienting it over a bin, and conveying the lemon into the bin. Several other examples of object manipulation have been demonstrated including grabbing, translating, and screwing in a light bulb. Demonstrations may be performed through teleoperating the robot with a custom-designed app that enables joystick control. An operator may be present to directly observe the operation of GRIP-tape, or a camera may be used together with the GRIP-tape system such that an operator can control GRIP-tape from a remote location.

The passive compliance of the tape appendage expands its capabilities when interacting with objects. For example, if there is an obstacle impeding the planned trajectory, the appendage is capable of deforming around the obstacle and continuing on its way to reach the desired ending position. If there is a known obstacle in the way that would prevent the appendage from reaching the target normally, the appendage can deform against the known obstacle and remain capable of grabbing and conveying the target object. The appendages may perform object grasping and conveyance when the appendages are deformed from contact with a wall.

The material properties of spring-steel and the cross-sectional curvature of the tape provides tape springs the robust ability for self-recoverability. A tape spring bent out of its original shape will snap back to its original configuration when released. If the appendage is struck while trying to complete a task, the strike causes the appendage to buckle. However, the appendage made of bidirectional tape rapidly rebounds and successfully completes the task. The tape spring material, the curvature of the tape spring, and the number of layers of tape spring used for an appendage may be selected based on the intended application for GRIP-tape (e.g., how heavy the target objects are, how likely collisions are, whether the operation space is confined or difficult to navigate).

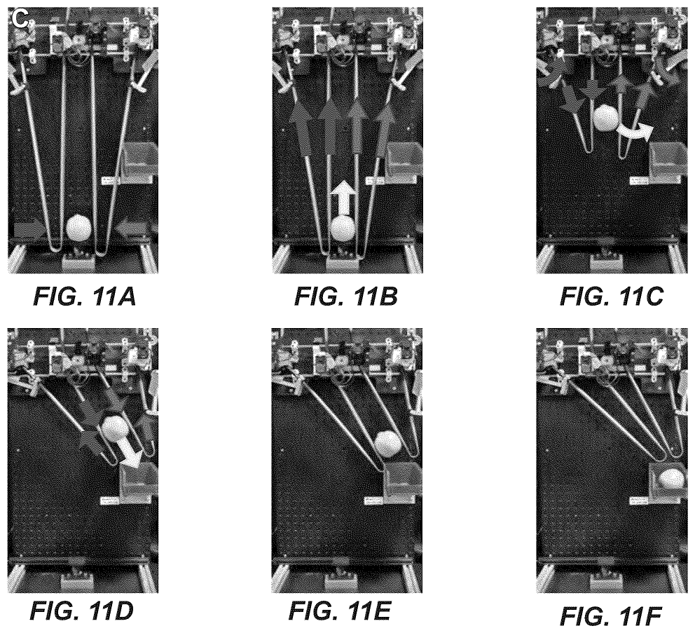

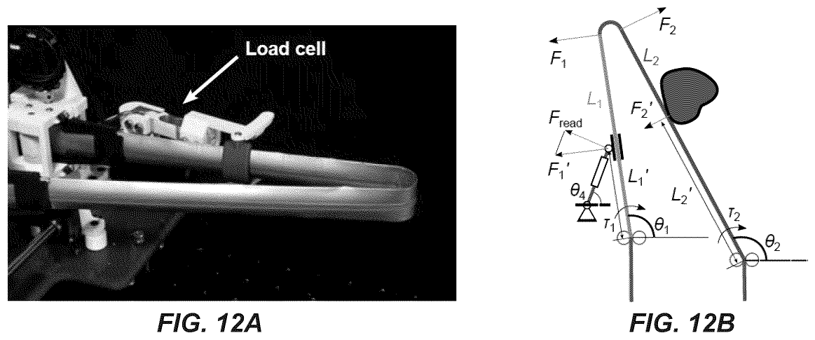

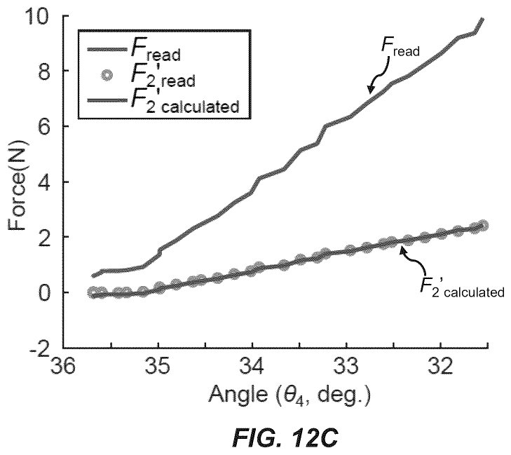

FIG. 12A shows a photograph of an example GRIP-tape appendage which includes a load cell on the angular control beam 512. The load cell allows for force feedback from the GRIP-tape, which can enable GRIP-tape to operate autonomously or semi-autonomously.

FIG. 12B shows a diagram depicting the balance of moment for the GRIP-tape appendage and load cell. Assuming the moments on each section of the appendage are balanced, and knowing θ₄, a, and L we can derive

$${θ}_{1} , {θ}_{2} , {L}_{1} , {L}_{1}^{′} ,$$

and L₂ by forward kinematics. The relationship between the force on the contact section and the read of the load cell is:

$${F}_{2}^{′} = ( ( ( \frac{{F}_{read} {L}_{1}^{′}}{cos ( {θ}_{1} - {θ}_{4} )} + {τ}_{1} ) / {L}_{1} ) {L}_{2} + {τ}_{2} ) / {L}_{2}^{′}$$

F_{read} is the reading of the load cell, and τ₁ and τ₂ represent the internal bending torque of the tape spring. To obtain τ₁ and τ₂ at different angles, we measured the internal torque with a folded bi-directional tape by folding it around a fixed point to a set of different angles. By curve-fitting these data with spline, we developed a relationship between the folding angle and τ. To demonstrate the force sensing accuracy we placed another load cell at the tip of the appendage with

$${L}_{2}^{′} = {L}_{2}$$

and we compared the force prediction from the base load cell with the actual contact force measured by the contact load cell.

FIG. 12C shows a data plot of the comparison between the real force on the tip of the appendage measured by the additional load cell and the calculated value F₂ derived from the force reading F_{read} on the base, demonstrating very good agreement.

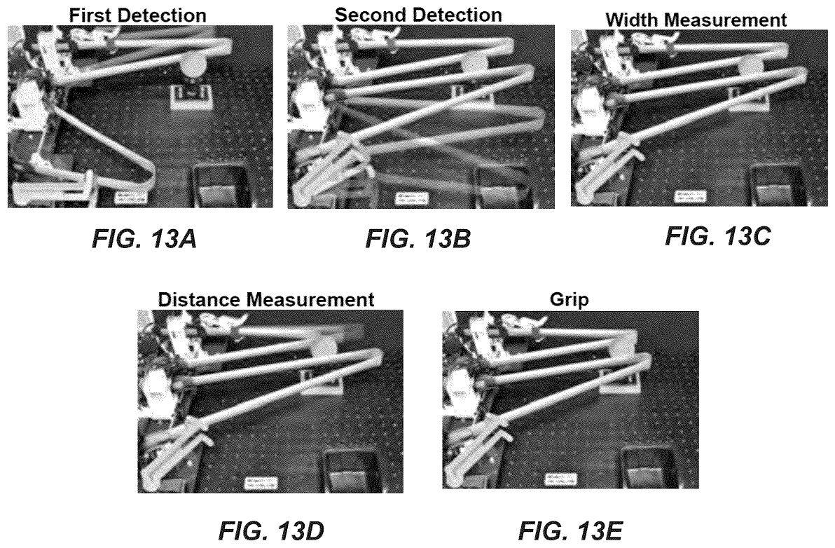

FIGS. 13A-13E show photographs of an example embodiment of GRIP-tape performing automatic detection, measurement, and gripping. The length of appendages and the force feedback in the GRIP-tape allow for locating the position of an object by searching with the appendages and grasping it autonomously by feedback based on force measurements by a force sensor. We designed several example motion steps to complete automatic gripping. In step 1 and step 2 (FIGS. 13A and 13B) we locate the object with the left and right appendages by sweeping first the left appendage inwards until contact is detected (force reading exceeds a predetermined threshold), and then the right appendage is swept inward until contact is detected. The steps end when an increase of the force estimate of the F₂ is detected with a contact detection threshold value of 0.25 N. After steps 1-2, the left and right appendages are both in contact with the object with a small amount of gripping force. The shapes of the appendages define a gripping axis along which the object is located by connecting the origin and the midpoint between the 2 coordinates of the appendages' tip. However, the robot has not yet determined the size of the object or the distance of the object along this center line. In some cases, for instance, the friction between the appendage and the object is low, the width of the object can influence the gripping because the angle between the appendages is larger than the self-locking angle so the object could fall out of grip no matter how large the gripping force is. The other reason to measure the width is to orient the contact section of the appendages parallel with one another to enable conveyance of the object. For step 3 and step 4, the GRIP-tape separates its appendages and reconfigures the contact sections to be parallel to the gripping axis and then the tapes are moved closer to each other while keeping the parallel configuration until contact is once again detected by the force sensor (FIG. 13C). This measurement step now provides the width of the object w which is the gap between the parallel contact section of the appendages. Lastly, to determine the object distance along the grip axis we retract the left appendage until contact is lost (measured by a sudden decrease in force from the force sensor, FIG. 13D). Once contact is lost, we mark the gap between the origin and the intersection point of the perpendicular drawn from the tip location of the left appendage to the gripping axis as the shortest distance d′ and the distance between the object and the origin is assumed to be the sum of half of the width w and the shortest distance d′. Once the object location has been determined in the workspace, we can move the two appendages to the sides of the location of the object, form a grasp (FIG. 13E), and move the object to the desired location.

Force feedback also enables the GRIP-tape system to provide closed-loop contact force control. This can be useful for example in cases where a non-round object needs to be rotated. Round objects can be rolled in the grip by simply moving the grasping surfaces of the appendage in opposite directions. The object roundness results in a constant grip force while the object rotates (since the cross-sectional width of the object is not changing between the grip points). While this open-loop rotation works well for round objects, objects of unknown or irregular shape pose a challenge for rotation in a grasp. The softness of the appendage tip can accommodate some small deviations in grip width variation. However, excessive width changes during rotation can lead to either loss of grip, buckling of the appendage, or slipping of tapes inside the tape extruder due to increased gripping force and excessive friction between the tapes and the guiding ring.

To address this issue, we implemented force feedback from the contact force sensor to achieve and maintain a desired gripping force during non-round object rotation. The feedback control adjusts the lateral spacing between the appendages to keep the desired force contact force constant. In some embodiments, the force controller is a simple control loop in which the contact force error is used in a proportional controller to servo the grip width. If the force reading is less than the desired force, the grip width between the appendage ends is decreased. If the force reading is higher than the desired force, the grip width distance between the endpoints is increased. Implementing this force feedback control allows for successful, controlled rotation of elliptical and other non-constant grip width objects.

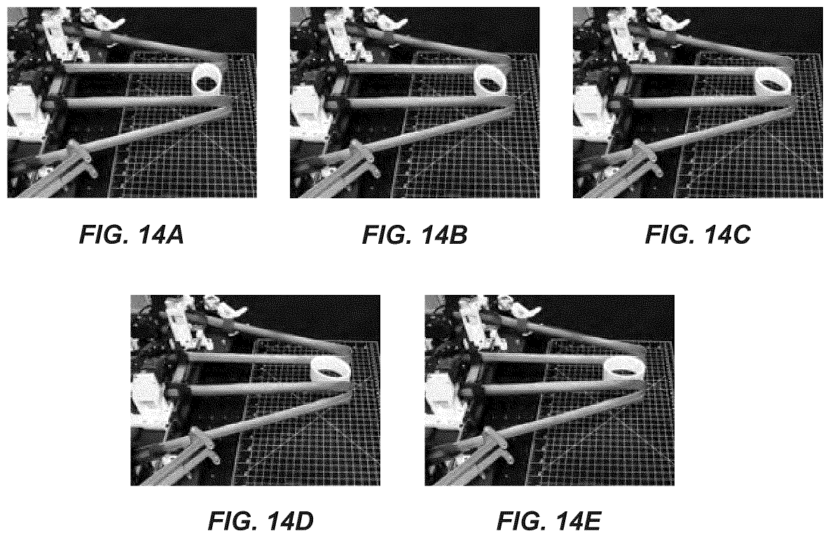

FIGS. 14A-14E show photographs of an example embodiment of GRIP-tape performing object rotation with force feedback. We compared the performance with and without force feedback by rotating an ellipse and demonstrate that open-loop rotation causes the object to be dropped, while closed-loop force feedback rotation successfully maintains a grasp during rotation.

After the functions and applications were verified on the planer platform we designed a more compact version of GRIP-tape that could be used as an end effector on a robot arm and aims to handle object size like human hands can handle. The robot arm helps to enlarge the workspace from planar to 3D in the applications of GRIP-tape. The system retains the same design and kinematics of the planar test platform while being implemented in a smaller package with integrated tape spools into its main body. The use of a robotic arm in combination with GRIP-tape can also expand the possible modes of operation for GRIP-tape. For example, a robotic arm may move autonomously (e.g., along a pre-programmed path) while a human operator controls the operation of GRIP-tape. Alternatively, a human operator may control the movement of the robotic arm, while GRIP-tape operates autonomously (e.g., using one of the force-feedback control mechanisms described above)

The design principles in this version of GRIP-tape are the same as that of the planar test platform, with both utilizing four drive actuators to control the length of a pair of extendable tape appendages. Adjustments for the smaller-sized design include combining the angular control link with the guide of the outer extruder, swapping the width control mechanism from a rack-and-pinion system to a timing belt, and integrating the spool.

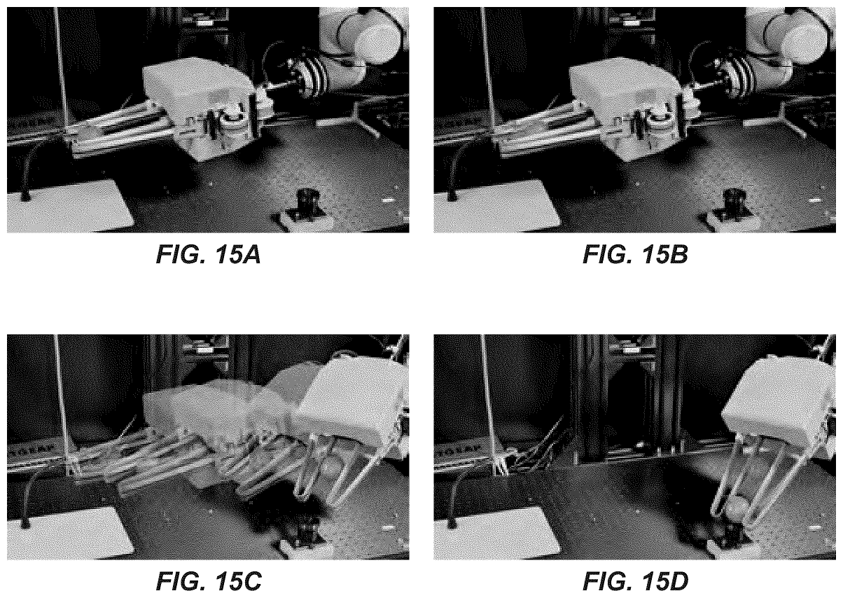

FIGS. 15A-15D show photographs of GRIP-tape used as an end effector for a robot arm harvesting a fresh tomato by twisting. With an end-effector-sized gripper, the robot arm expands its capabilities from planar to 3D operations. Leveraging the added degrees of freedom, we replicated the tomato twisting and picking demonstration with a larger tomato, achieving a more accurate and secure picking and dropping.

FIGS. 16A-16D show photographs of the example GRIP-tape end effector used to open and pour a pepper canister. We used the end effector to do multi-step manipulation tasks such as a combination of object rotation about the z-axis (untwisting a cap) and rotation about the x-axis enabled by the robot arm.

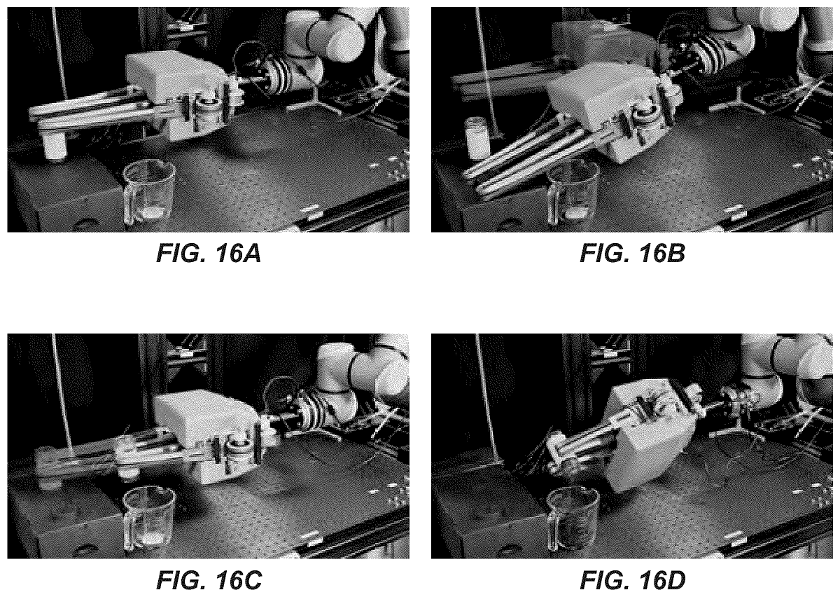

FIGS. 17A-17D show photographs of a potential application of the GRIP-tape end effector in reaching through the leaves of a plant, grasping a jalapeno, and then twisting the pepper off the stem and pulling it from a plant. The arm enables the precise targeting of the GRIP-tape appendages while the deployable action of the tape spring finger allows for reaching and manipulating the object.

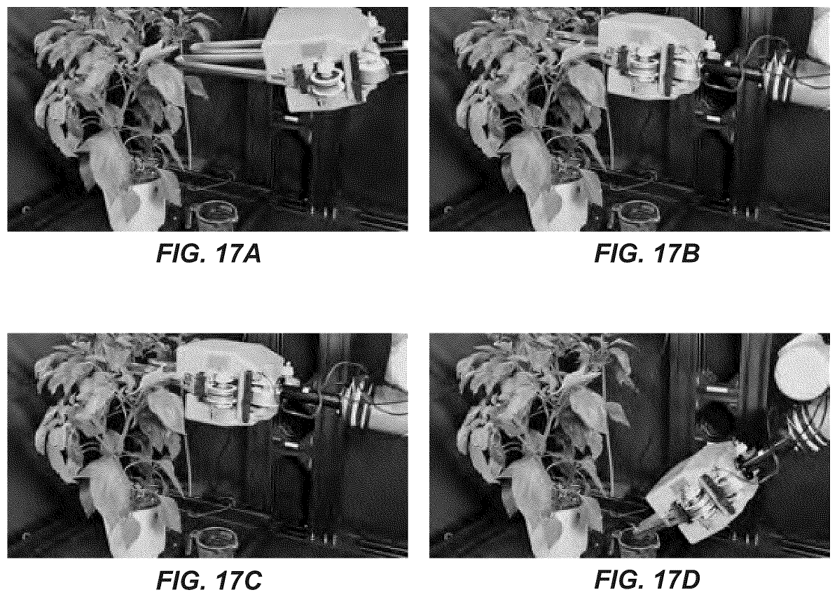

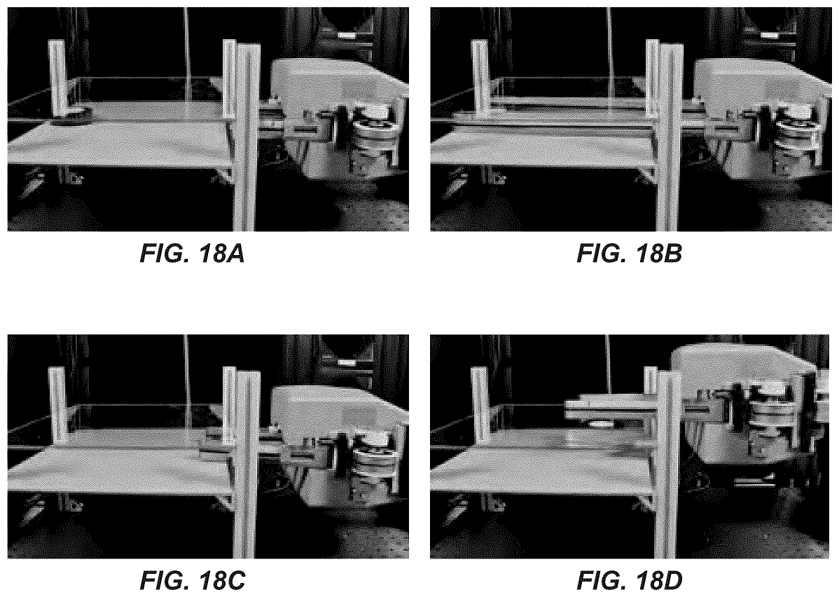

FIGS. 18A-18D show photographs of a GRIP-tape end effector reaching into a narrow gap. The combination of the tape appendages' extensibility and the z-axis degree of freedom enables the system to reach into a narrow gap and move an object from one layer to another through the small gap.

### Example Features and Benefits of Bidirectional Tape Spring Appendages

Herein, we have presented the design and testing of some example embodiments of GRIP-tape, a soft robotic gripper constructed from tape springs. The GRIP-tape has several advantages, including compliance allowing for interaction with unknown or complex objects, being inherently safe for human interaction, and being able to reconfigure its own shape. The tape appendage mechanism keeps the beneficial properties of robot compliance while also adding additional capabilities for simple in-hand rotation and high extensibility. Thanks to the features of tape springs, the inherent maximum load and self-recoverability of tape appendages provide safety during interaction and ensure robustness in gripping applications. Owing to the continuity and consistency of the tape appendage, the rolling mechanism allows for the seamless renewal of material if any part is permanently damaged during operation, eliminating the need for complicated manual operations. Additionally, due to their geometrically defined shape the tape appendages can be precisely controlled. These features make the GRIP-tape a versatile system, well-suited for a variety of applications encompassing object gripping, dual modes of translation/rotation, multi-object conveyance. Additionally, GRIP-tape can be adapted to a variety of use cases through appropriate tape design and selection of motors and actuators. GRIP-tape can be used in combination with other robotic systems (e.g., a robotic arm) or as a stand-alone platform.

A significant capability of the GRIP-tape is the ability to rotate objects in place while in a grasp. Grippers have been developed with similar capabilities; however, they have relied on the integration of active surfaces such as conveyor belts mounted onto a traditional gripper. However, the need for rollers within the fingers or the finger's supportive skeletal structure for the “conveyor belt” constrains the choice of materials for constructing the fingers, thereby restricting their flexibility. In contrast, the material properties and deployable nature of GRIP-tape's appendages alleviates these challenges by using the compliant structure of the appendage as the active surface for manipulation.

The tape appendage structure also allows for sensing and haptic feedback during use operation. We have demonstrated sensing and feedback capabilities using the load cell embedded in the angular control beams. The load cell can measure the force applied to the appendage and then the applied force can be calculated. We can map the force reading of the load cell to the force applied to an object anywhere on the appendage as long as the location of the object is known. Object locations may be tracked using a camera integrated with the system. These capabilities allowed for the development of automatic functions such as searching, measuring (size and location), and gripping using built-in force measurements and structural compliance. Furthermore, the applied force can also be estimated by an operator through visual inspection, as the radius of curvature at the ends of the appendage decreases when the gripping force increases. This could allow a trained operator to judge at a glance how much force is being applied at any given time while teleoperating the GRIP-tape system. That is also why our forward and inverse kinematic model for translating the object includes the curvature at the tip of the appendage as a variable.

Examples of potential applications for deployable manipulators include agriculture, space, and sea environments. Agriculture remains a challenging environment for robotics as it is unplanned and variable, requiring a capability for adaptation. Additionally, for a robot to be adopted on a farm it must be both low cost and safe around humans. The GRIP-tape system may find use in agriculture applications where autonomous picking and inspection are required. The tape springs that form the actuated appendages are both cheap to produce and safe to use for human interaction due to their buckling properties. Furthermore, the different actuation modes of the GRIP-tape could be particularly useful in picking applications; for example reaching out and grabbing a fruit, twisting it off the plant, then retracting and conveying the fruit back to a central body for inspection. In these example applications, GRIP-tape offers advantages in soft gripping and reachability. The compliant and spring-like nature of the end joint would allow for force control while harvesting produce and would lower the chance of damaging a fruit while harvesting it. Autonomous detection and measurement can also benefit from the length of the arms, an object can be first approximately located by one or multiple visual sensors and further located by the extended arms.

In addition to agriculture, the lightweight and high extensibility of the GRIP-tape manipulator could be useful in environments where volume and weight are at a premium such as space. A tape spring-based actuator could be effective in space systems such as antenna booms, satellite solar arrays, and structural supports, allowing for highly extensible actuators to be sent on space missions with substantially lower weight and volume than rigid link robots with the same reach distance. Similarly, an extensible gripper could be useful in deep sea environments where space is limited within the vehicle. Sea caves are complex and space limited environments that are interesting places to search for new life. The narrow constraints of the caves limit the equipment that can be carried inside, motivating the use of actuators that can be packed into a small volume and then extended.

There are further variations and modifications of the GRIP-tape embodiments disclosed here, some of which will be discussed in subsequent sections. First, there are some objects (e.g. those with sloped or irregular surfaces), which are difficult to grasp when only two appendages are used. Introducing an additional appendage and adopting a triangular layout (or further expanding to a four-appendage configuration) can substantially expand manipulation capabilities, enabling better performance with at least one supporting appendage positioned beneath the object. For example, two sets of grippers could be arranged in a perpendicular configuration, or three appendages in a triangular arrangement, which not only provides a more secure grip but also introduces an additional degree of freedom. With more than three active surfaces, where any two can define a rotation axis, the system can generate all possible rotation vectors within a plane. The remaining rotational dimension can be managed by a rotary stage, enabling full 3D rotation. Additionally, multiple appendages offer a more stable grip compared to bimanual gripping.

In addition to expanding the number of appendages, surface treatments may be applied to the tape to further improve gripping stability.

### Example Materials and Methods

### Fabrication

The fabrication setup mirrors the design mentioned in previous sections, utilizing a 450 mm×200 mm acrylic base to house fixed and movable extruders. Two extruders on the far left and right directly manage the appendages' supporting sections, while two central extruders, positioned on a track, are guided by a rack-and-pinion mechanism for precise linear motion. This motion is stabilized by two 8 mm metal rods serving as guiding tracks, with smooth travel facilitated by linear bearings. The system is powered by seven DYNAMIXEL motors, including five XL430-W250-T units for length and gap control of the appendages and two XM540-W270-T motors for angular adjustments.

The extruder design incorporates active and passive rollers mounted on shafts supported by 5 mm×10 mm×4 mm bearings, with sandpaper-coated rollers enhancing friction. Each extruder includes entrance and exit guides designed to accommodate tape deformation, ensuring uniform support and preventing undesired bends caused by compression or external forces. For angular control, the unit features a guiding ring mounted 115 mm away from the motor axis, with an offset rotational axis to minimize collisions between the beam and tape during movement. An “X”-shaped stabilizer further supports the guiding ring, ensuring the tape remains upright in section view, contributing to improved gripping performance.

### Motion Programming

The programming framework for GRIP-tape, developed using MATLAB and DYNAMIXEL Protocol 2.0, enables precise control and real-time feedback for the gripper's movement and configuration. The system coordinates 7 DYNAMIXEL motors using built-in PID controllers and a load cell for force feedback. Basic functions include forward kinematics for appendage positioning and modes for appendage transformation: “Tip remain” mode maintains consistent contact geometry, “Outer only” mode adjusts outer appendages for object manipulation without angular displacement, and “Inner only” mode exclusively moves central extruders along the track.

For object gripping and manipulation, the program adjusts the distance between inner extruders to ensure parallel contact for equalized gripping forces. Translation combines gripping with appendage transformations along calculated waypoints, minimizing mid-way drops caused by non-linear forward kinematics. Object rotation and conveying are achieved by synchronized appendage motions, where same-direction movements induce object rotation, while opposite-direction movements enable conveyance.

We developed a MATLAB-based app which enhances usability, featuring sliders for position and force control, real-time appendage layout visualization, and emergency stops. An “Auto” function integrates object detection, measurement, and gripping. Gamepad controls (Logitech F310) further facilitate manual adjustments, enabling intuitive manipulation of location, gap, and gripping force, along with object rotation and conveying functionalities.

### Mechanical Testing

We used two experimental setups to characterize the mechanical behavior of the tape spring appendages. The first setup, a MARK-10 ESM750S Motorized Tension/Compression Test Stand with a MARK-10 M7-20 force gauge, was used to evaluate the three-point bending strength of various tape configurations and the stiffness of the appendage's tip curve. This setup allowed precise measurement of loading vs displacement curves.

The second setup focused on measuring the buckling strength and durability of the appendages. It included a rotational stepper motor (SOYO SY42STH38-1684A), a rotary stage (Parker 30005-S), a load cell (YZC-133 1KG), and an amplifier (FUTEK IAA100). In this experiment, the straightened appendage was mounted on the rotary stage driven by the stepper motor and rotated into contact with a fixed-load cell at defined distances, providing data on the appendage's resistance to buckling and its performance under repeated loading.

### Kinematics Experiment

The accuracy of the GRIP-tape appendage control was evaluated using a motion capture software OptiTrack Motive and OptiTrack Primex 13 cameras. We performed two sets of experiments to characterize the theoretical kinematics model compared to the actual appendage motion. In the first experiment we commanded the appendage to move to 16 locations across a 4 by 4 grid over the workspace (FIG. 7), with 6 trials for each location. In the second experiment we commanded the appendage tip to move along different xy paths over three cycles.

### Example Designs for Looped Tape Spring Appendages

In some embodiments, a tape spring-based gripper may use tape spring structures which include tape-spring loops to form one or more pairs of gripping fingers. The mechanical properties of the tape-springs allow them to hold their shape without any other support along their length and thus each forms a “free-standing” shape similar to that of a tank tread. To enhance gripping strength, a TPU exoskeleton may be added over the tape which provides local compliance along the gripper. Mechanical characterization of the tape-spring and exoskeleton fingers are described below, and we compare the pull-out force characteristics for various configurations of the digits. A feature of this looped tape design is that they can be continuously actuated by drive actuators and thus can continuously rotate/translate objects in a grasp. Some embodiments may include four gripping appendages. For each appendage, each tape velocity is independently controlled, providing for control of four unique contact velocities with an object allowing for a wide range of rotation axes. We demonstrate the manipulation capabilities of this gripper through grasping and handling of spherical and cylindrical objects.

Disclosed are manipulators that use a closed-loop tape-spring structure to grasp and re-orient objects so that the contact velocity in a grasp can be continuously controlled with no end limit. Active surface grippers present opportunities for manipulation because they combine the stability of underactuated grasping with the fine-scale manipulation capabilities of active surface. One drawback of active surface grippers is that they can have difficulty in manipulating objects that drastically change in curvature (e.g., a cube). This limitation is commonly due to the lack of compliance in the gripper systems. The use of soft active surfaces has been explored to address the issues of contact compliance. Elastic band grippers, fin-ray, and bio-inspired adhesives have been developed. For example, an active surface gripper that was constructed with an elastic conveyor belt enabled objects to be enwrapped and held tightly. Gecko-inspired adhesive surfaces have also been used to improve gripping performance.

The present designs employ soft gripping surfaces that can provide adaptive surface conformation along the entire length of the gripper, thus allowing for manipulation capabilities along the length of the active surface. The full-length utilization of tape spring structures also enables a potential application in multi-object gripping. Our approach achieves this by modifying the tape-spring's gripping surface to enhance local compliance and adapt to objects with different dimensions during manipulation tasks.

Building on the GRIP-tape embodiments previously described, we added an additional pair of fingers to the previous two-finger design. This four-finger configuration creates a “nest” that secures objects within the grasp and reduces slippage. To further improve gripping performance, we introduced a soft exoskeleton around the fingers, enhancing adaptability and contact with various object surfaces. Additionally, the four-finger setup expands the gripper's manipulation capabilities: while the previously described two-finger embodiments of GRIP-tape could rotate objects along a single axis, the four-finger design enables rotation around both the z-axis and x-axis, allowing for greater flexibility in object orientation and manipulation.

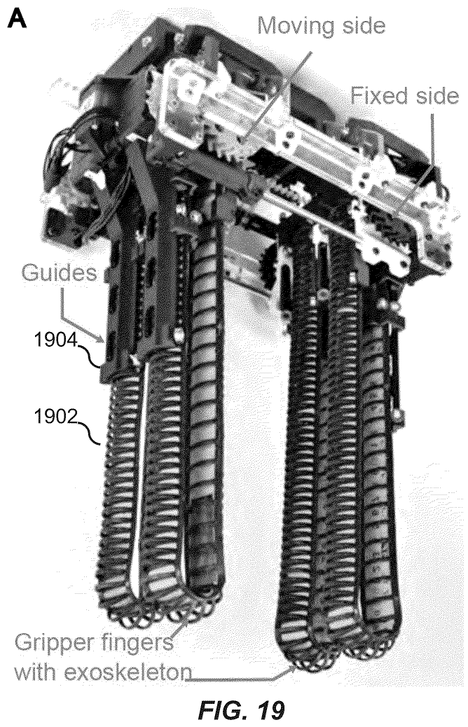

FIG. 19 shows a photograph of an example looped tape spring gripper. In some embodiments, the gripper is designed with four fingers 1902 made of closed loop tape springs independently driven by Robotis Dynamixel XL430-W250 drive actuators, providing precise control over the movement of each finger. The position of each finger is maintained by a guide 1904. A gear transmission for each actuator reduces the height of this mechanism's gripping module, where each looped tape is driven directly by a motor, as well as generating a higher torque. The four gripper fingers 1902 are arranged in two pairs to construct a parallel jaw gripper layout in this example design. For simplicity, in this example the right side is fixed to the mounting frame, establishing a stable foundation, while the other side is movable, allowing for adaptive gripping and increased range of motion. In the embodiment shown, a parallel jaw gripper configuration was selected because this layout simplifies the mechanism's design and its control strategy. The parallel jaw configuration also allows the gripper to manipulate objects with more diverse shapes and dimensions, which is particularly useful for tasks that require different grip sizes or orientations.

Both the fixed and moving side of the manipulator features symmetric upper and lower layers. Both layers feature a continuous tape-spring loop structure driven by rollers covered in sandpaper, enhancing grip and minimizing slippage. The symmetry between these layers contributes to balanced movement and even distribution of forces during operation. Each side of the gripper has a fastening cage with tension springs at each corner to secure both closed loop tape-springs within the structure and provide adjustable pinching force on the exoskeleton over the tape, ensuring consistent contact between the drive roller and the exoskeleton's guiding fin and improving control over each loop's motion. Additionally, to offset deformation in the support and contact sections of each looped tape finger 1902, a pair of guides 1904 is mounted for each finger, with the guide on the exterior on each finger longer than that in the interior. The exterior guide is slightly angled inward to offset the tape-spring structure's deformation due to loads during gripping and keep the contact sections parallel during gripping, helping conveyance of the object and maintaining sufficient gripping force at the tip of the gripping tape (see FIG. 19). Eight pairs of bearings are carefully positioned on the main structural part and the fastening cage to guide the tape in the desired direction, providing stability and maintaining alignment throughout manipulation tasks (see FIG. 19).

The width between the two sides can be adjusted using a gear system located on the moving side and a rack mounted on the frame. This mechanism allows for fine-tuning the distance between the sides, enabling the gripper to adapt to objects of various sizes. The gear and rack setup provides a simple yet reliable method for adjusting the gripping width, which enhances the versatility of the manipulator.

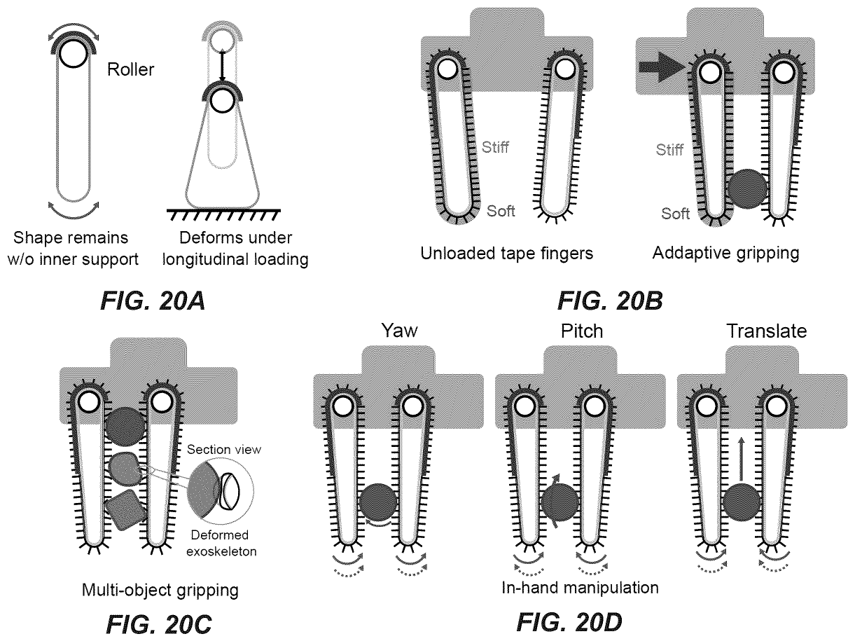

FIGS. 20A-20D show schematics illustrating various features and capabilities of the gripper shown in FIG. 19. FIG. 20A demonstrates that the compliance of the closed loop tape springs allows it to deform when colliding with obstacles. FIG. 20B illustrates that tape spring structures are stiff at the majority of their length and soft at the buckled region, enabling adaptive gripping when used as gripping fingers. FIGS. 20C and 20D illustrate in-hand manipulation capabilities of this gripper.

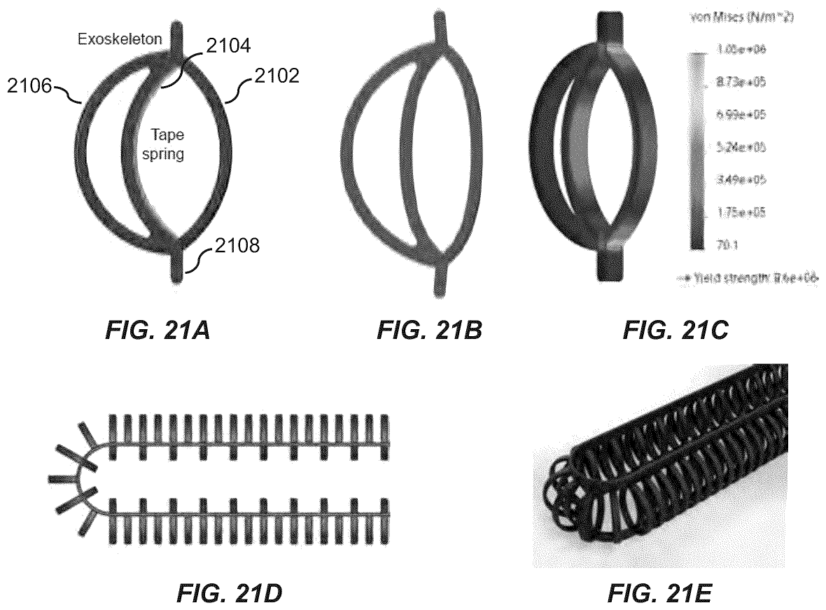

FIGS. 21A-21C show cross-sectional slices of the looped tape gripper exoskeleton. The exoskeleton is designed to enhance gripping performance while preserving the essential properties of the tape spring. To maintain the tape's softness for smooth rolling within the loop, the exoskeleton is segmented into slices, with each slice consisting of an inner support 2102, an outer support 2104, and a contact curve 2106. To ensure that the tape springs retain rigidity on their convex side and avoid any preload that could cause flattening, the outer support of the exoskeleton is contoured to match the curvature of the tape spring (see FIGS. 21A and 21B, which depict the exoskeleton slice with and the tape spring, respectively). In addition to the outer support band 2104, inner support bands 2102 are included to secure the tape within the exoskeleton and help balance some tension on the outside. Beyond the supporting bands, a concave surface with a smaller radius is introduced on the gripping surface to increase flexibility, enlarge the contact area by adaptive deformations, and better secure the object within the nest.

The flat surfaces 2108 at the top and bottom of the exoskeleton serve as guiding fins that the drive roller directly contacts to actuate the tape loop. These flat surfaces also directly contact with the bearings fixed on the structural parts of this gripper to guide the tapes' moving direction when actuated.

As the tape spring flattens in the fold region, its width increases. To accommodate this change, we selected TPU 95A as the material for the exoskeleton and utilized 3D printing for fabrication. FIG. 21B illustrates the deformed shape of a section view of the exoskeleton. We analyzed the stress in this area (results shown in FIG. 21C), where the exoskeleton experiences the highest average stress. The results indicate that the maximum stress occurs between the inner support and the guiding fin, remaining below 15% of the yield strength.

For fabrication, the discontinuous design of the rings on the exoskeleton, combined with its softness, led to unsuccessful attempts at establishing a curved or flat surface at the bottom for 3D printing. We achieved the best printing quality of these exoskeleton segments by letting those segments stand on one of their guiding fins 2108 on the print bed.

FIGS. 21D and 21E show the overall shape of the example exoskeleton.

We note that other compliant material layers or structures (e.g., foams, rubbers, gels, etc.) may be used in combination with looped tape springs to achieve similar compliant properties to the example exoskeleton described here. This example exoskeleton was selected to be compatible with the gear mechanism used to actuate the looped tape springs in this embodiment, as repeated contact with the gear mechanism can cause damage or degradation of the compliant layer. In other embodiments using different actuation mechanisms, an appropriate compliant material layer may be selected.

The tape spring loop structure covered by the exoskeleton is made by forming three loops of tape measure segments and laminating them together to form a three-layer loop. In this example embodiment, tape measures are chosen for the tape spring structure material because they are readily available in large quantities.

Design parameters, including the length and thickness of the looped tape springs, may be selected based on balancing the gripper's performance and its compliance. Longer tape loops allow the gripper to manipulate more objects simultaneously, but at the cost of weaker pinching force at the tape loops' tip due to longer moment arms, more material consumption, and increased manufacturing difficulty. For the tape spring loops shown here, the gripping fingers are not designed to be retractable, longer tape loops also increase the space this gripper occupies, making it harder to maneuver in space. For the examples discussed herein, we choose 30 cm as the appendage length for our gripper.

The number of layers or thickness of each tape loop in a tape spring structure may be chosen to balance the stiffness and flexibility of the tape. Each tape loop can be formed by connecting both ends of a tape measure segment after wrapping the tape in the desired number of times. This method reduces the discontinuity of thickness at the connection location, although it cannot guarantee an absolutely uniform thickness across the loop. Increasing the number of layers reduces the sudden change in thickness at the connection point and allows the looped tapes to operate more smoothly and withstand higher loads before buckling, but a higher stiffness makes the structure less flexible. Considering the application of our gripper, we selected 3 loops of tape for each loop appendage.

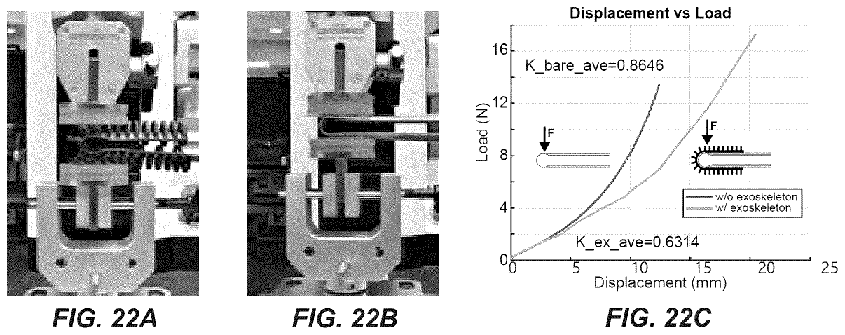

FIGS. 22A and 22B show photographs of a pressing experiment on example tape springs, with and without an exoskeleton, respectively. The fold region of the buckled tape provides some inherent softness for gripping. We hypothesized that adding a soft exoskeleton will further reduce the stiffness. To quantify the added softness, we conducted a pressing experiment using the Mark 10. The tape spring structure for the experiments is made of 2 layers of tape spring bounded by duct tape.

FIG. 22C shows a data plot of the displacement versus load curves of the tape spring structures with and without exoskeletons. By comparing the displacement vs. load curves, we found that the stiffness of the tape with the exoskeleton decreased by 0.2332 N/mm from an average stiffness of 0.865 N/mm. The average stiffness of the exoskeleton is calculated to be 2.3409 N/mm. This reduction in stiffness means that, with the exoskeleton, the gripper can handle more delicate objects.

To validate the exoskeleton's functionality, we constructed a simplified model for testing. A pair of load cells was placed on one side to ensure a constant preload throughout a series of experiments. We evaluated performance in four configurations, including bimanual and 4-finger gripping with both bare tapes and exoskeleton-covered fingers.

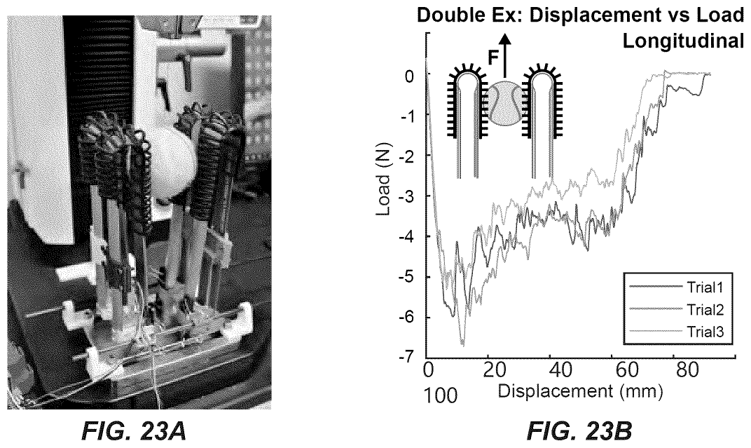

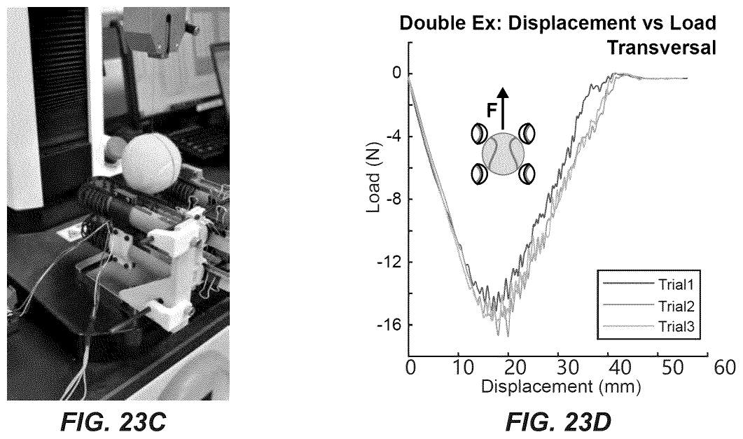

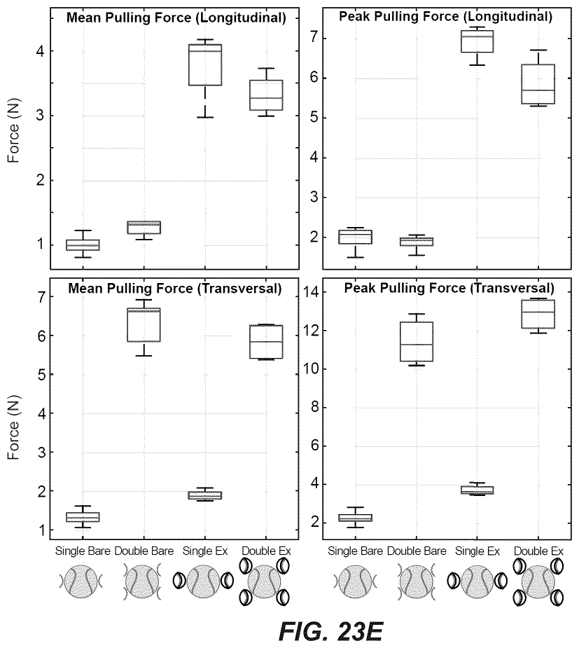

FIGS. 23A and 23C show photographs of experimental configurations for the measurement of the longitudinal and transversal pulling forces by two pairs of fingers with exoskeletons, respectively.

FIGS. 23B and 23D show data plots of the displacement vs load curve of 2 sets of fingers covered with an exoskeleton during 3 trials for the longitudinal and transversal directions, respectively.

FIG. 23E shows a comparison of the mean pulling force and the peak pulling force for the longitudinal and transversal directions for either single or double pairs of grippers, with and without exoskeletons. In the longitudinal case, the exoskeleton significantly improves performance, though the addition of two extra fingers was less effective; the pulling force was even lower than in the bimanual case, despite the 4-finger grip performing better with bare tapes. A possible explanation is that in the bimanual configuration, the gripping force is concentrated on one finger pair, which deforms the exoskeleton more and increases friction over twice as much as the friction increase caused by deformation on each finger pair in the 4-finger configuration.

For the transverse pulling experiment, the exoskeleton showed less noticeable improvement in the 4-finger configuration. However, adding the second pair of fingers markedly increased tipping performance. Note that the preload was 6N for the longitudinal case and 5N for the transverse case, so comparisons are only valid within each respective direction.

### Example Looped Tape Spring Appendage Capabilities and Demonstrations

We conducted several experiments to demonstrate the capability of the four digit looped tape spring gripper to manipulate objects within the mechanism, including conveying the grabbed object and rotating it in different rotation axes. The first experiment involves grabbing and manipulating a lemon and an orange within the gripper.

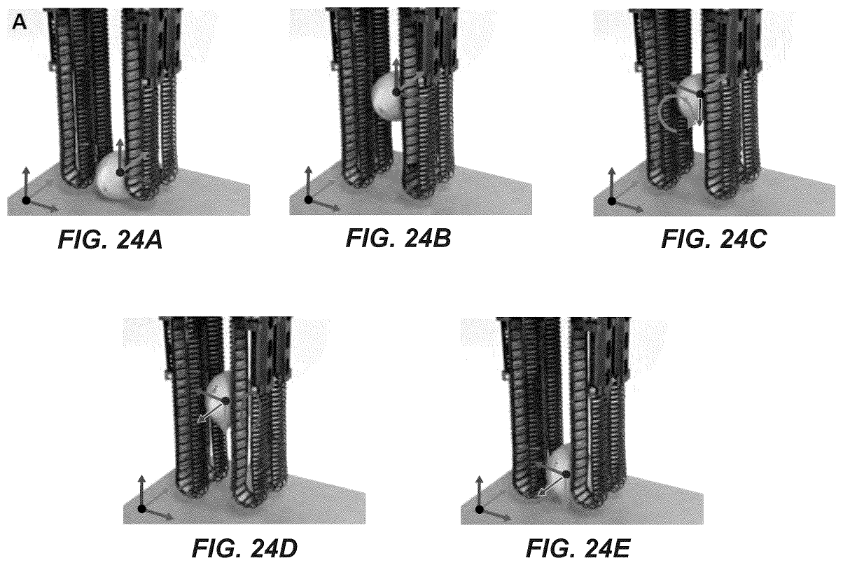

FIGS. 24A-24E show photographs of the example gripper grabbing and manipulating (via object translation and rotation) a lemon. The demonstration with a lemon includes a sequence of motions, in which the gripper was controlled to grab the lemon, convey it inward, rotate the lemon in various rotation axes, and finally put the lemon back onto the platform. Through this experiment, we showed that by controlling the moving speed of each looped tape spring structure independently, this gripper is capable of translation and multi-axis rotation of nonuniform-shaped objects such as oval-shaped objects within the mechanism.

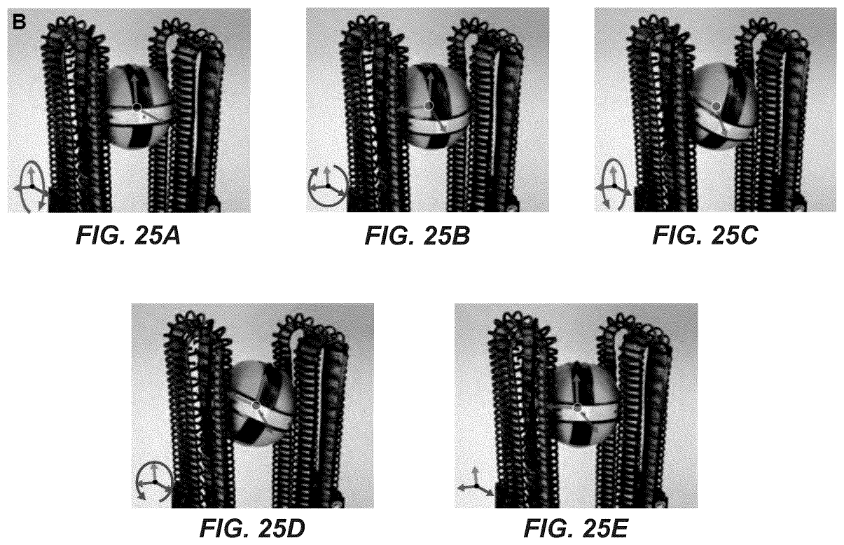

FIGS. 25A-25E show photographs of the example gripper grabbing and rotating an orange. Another function brought by the additional pair of gripping fingers is the ability to rotate objects in a not directly controllable direction by a combination of small rotations in the directly controllable ones. This ability is shown by rotating an orange in the roll axis (the vertical axis shown in FIGS. 25A-25E), which is not directly controllable by our gripper, through a series of pitch, yaw, negative pitch, negative yaw rotations, which are the gripper's two controllable rotation directions. For FIGS. 25A-25E, the gripper rotates the orange in a sequence of negative pitch, negative yaw, pitch, and yaw directions, resulting in a rotation about the roll axis. Rotation directions are shown at the bottom left of each figure The orange used in this demonstration is covered with tapes and markers to better visualize the rotations.

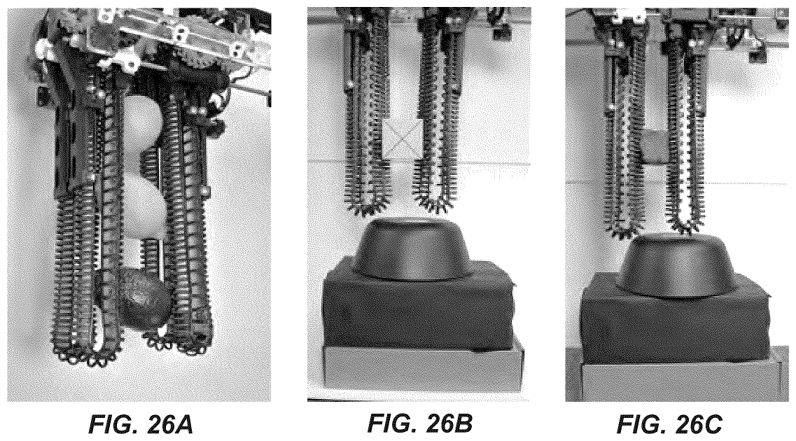

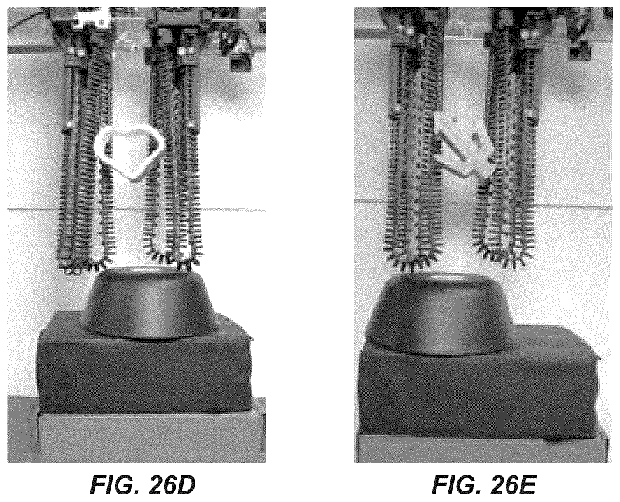

FIG. 26A shows a photograph of an example gripper grasping multiple fruits with different dimensions simultaneously. The full length of the tape fingers can be used in object manipulation tasks, allowing this gripper to handle multiple objects simultaneously. The compliance provided by the tape-spring structure, especially by the extra concave layer on the soft exoskeleton, allow the gripping fingers to locally adapt to objects with different widths.

FIGS. 26B-26E show photographs of an example gripper manipulating objects with non-uniform grasping widths. This demonstrates this gripper's ability to adapt to objects with non-uniform width during object rotation tasks. The compliance of the tape-spring structure allows the gripping fingers to adapt to the changes in gripping width of the rotating objects without changing the width of the gripper and without requiring sensing electronics or force control algorithms. The examples of manipulating the heart-shaped object and the toy trident also show comparisons between the deformed tape fingers in the front and the unloaded ones behind, providing visualizations on how the tape fingers adapt to changes in gripping width of objects during rotation.

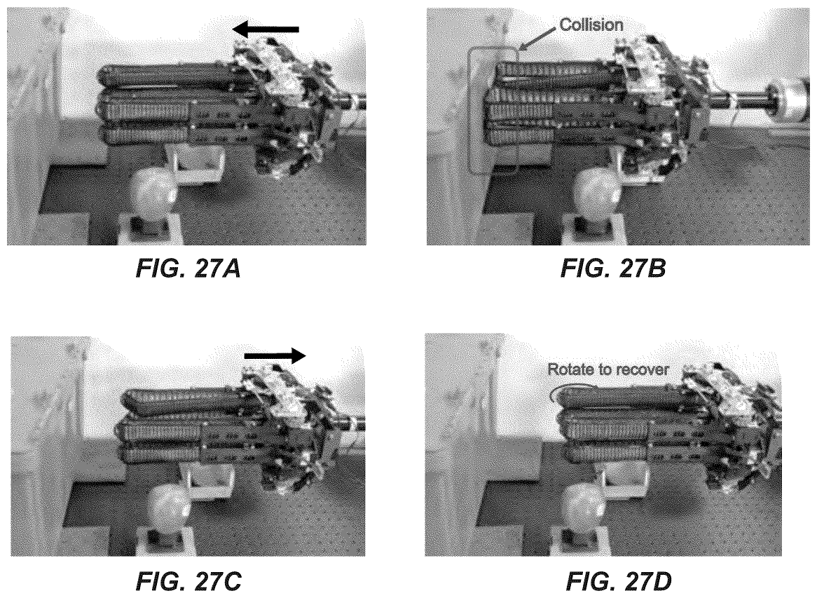

FIGS. 27A-27D show a series of photographs of an example gripper in which the gripper mounted on a robot arm was pushed into the obstacle. Upon collision, the tapes buckled and the gripper was retracted from the obstacle. Some tapes were able to recover themselves and all tapes were actuated outward to ensure they are fully recovered from collision. The gripper maintains all its functions after recovering from collision. This example demonstrates the mechanism's ability to self-recover from a collision and maintain its object manipulation functionality.

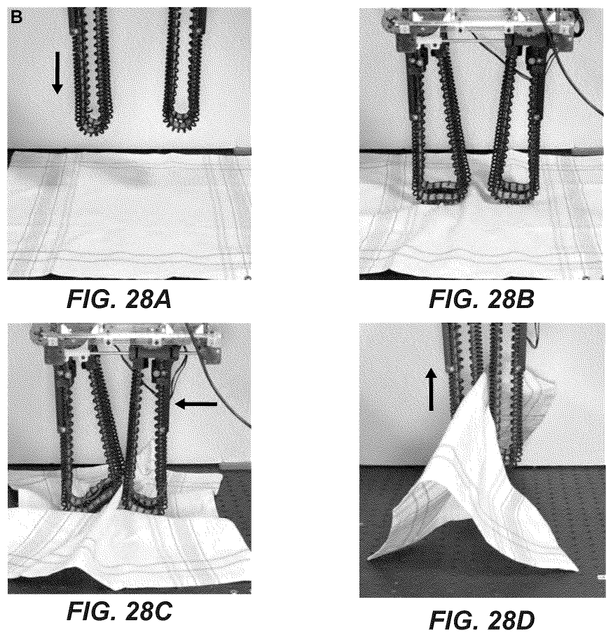

FIGS. 28A-28D show a series of photographs in which an example gripper is used to pick up a cloth napkin. The gripper mounted on the robot arm moved downward to grab the cloth napkin and the gripper fingers buckled as they collided with the table. The gripper closed as the tape loops were actuated inward to pull the napkin inside the gripper, and the gripper was lifted up after successfully grabbing the napkin. When the fingers adaptively deform along a planar surface, friction between the gripping fingers and the surface can assist in pulling in soft and thin materials as the tape fingers are driven. The soft exoskeleton of the tape-spring gripping fingers significantly increases this friction, which reduces slipping while grabbing objects.

An additional example showing this gripper's ability to safely interact with the environment is the experiment of taking of a glove from a person's hand. In this experiment, a person put her gloved hand between the gripper's two sides. As the gripper closes, the TPU exoskeleton's soft surface is able to adapt to the geometry of the hand, and the gripper is able to take off the glove by actuating the tape loops without inflicting any damage.

In addition to deformations on the tip of the fingers, tape springs have an important safety feature: they buckle when the bending torque exceeds a certain threshold, causing the area to flatten and lose nearly all load-bearing capacity. This property is particularly advantageous for interactions with humans or animals, as it provides a built-in limit on the gripping force, which is fully recoverable after buckling, functioning similarly to a circuit breaker.

An example that demonstrates the comprehensive utility of the gripper is the experiment where a cucumber initially placed vertically was reoriented by the looped tapes of the gripper to align with a horizontal hole and be inserted through it.

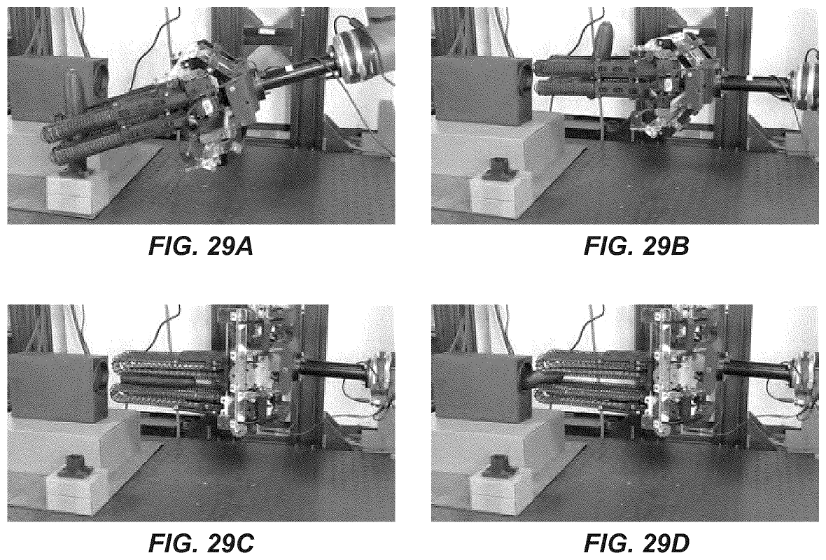

FIGS. 29A-29D show a series of photographs of an example gripper picking up a cucumber and depositing it in a box. In this experiment, the gripper mounted on a robot arm reached to grab the cucumber and move to the position to drop the cucumber through the hole on the black box, while the looped tapes convey the cucumber inward and reorient the cucumber to be aligned with the hole on the black box. Finally, the cucumber was inserted through the hole in the black box using the looped tapes that now act as conveyor belts. Multi-axis rotation enabled by the additional pair of gripping fingers of this gripper allows the object to be reoriented inside the gripper to perform other operations, which reduces the need to reposition the entire robot arm to change the orientation of objects.

The multi-axis continuous manipulation ability of this gripper can be applied in agricultural harvesting tasks. For example, after the gripper has reached the fruits on a tree, the gripping fingers were continuously driven to twist the fruits from their vines, which reduces the damage to the fruit tree compared to pulling the fruit from the vine directly.

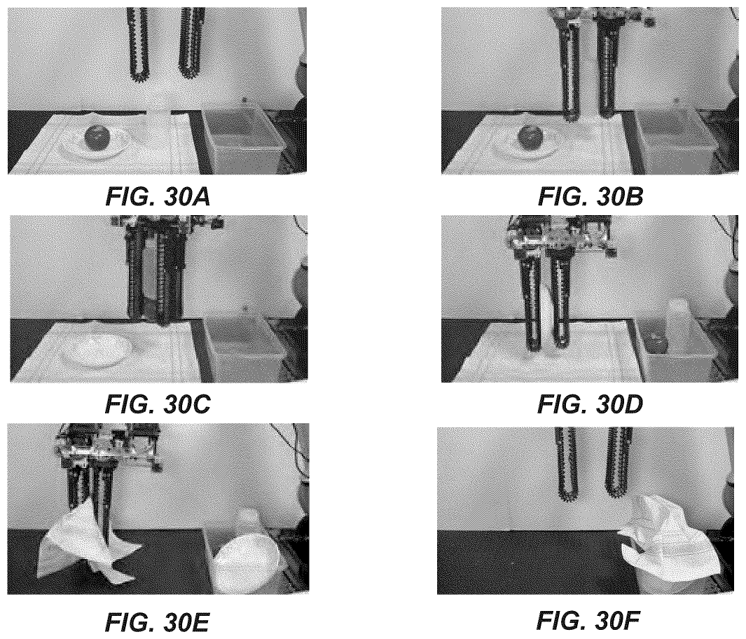

FIGS. 30A-30F show photographs of an example gripper performing an example task where the gripper utilizes its various capabilities to clean up the table by removing several items from the table and placing them into a bin. The gripper first grabbed the bottle and the apple in one grasp and then placed them at their desired locations inside the bin. The gripper then proceeded to grab and place a plate and a cloth napkin into the bin using the gripping fingers' ability to deform into surfaces during collisions and pull objects into the gripper using the additional friction provided by the soft exoskeleton.

The closed loop tape springs in the disclosed gripping mechanism serve as both the light-weight structural component of gripping fingers and the continuous active surface that functions like conveyor belts, which reduces the design complexity. Using tape springs as the gripping fingers' flexible structural component also enables the ability to self-recover from collision as shown in FIGS. 27A-27D, and the closed loop tape-spring design allows the gripping fingers to manipulate objects in-hand without end limits. The flexibility of the gripping fingers allows the gripper to handle objects with nonuniform gripping width like cubes, elliptical objects, and irregular shaped objects without any sensing and force control algorithms. The addition of an additional pair of gripping fingers significantly strengthens the maximum pull-out force in the transverse direction, as shown in FIG. 23E, and the four gripping fingers also form a cage that secures the object within the gripper like the example in FIGS. 29A-29D.

The 3D-printed soft TPU exoskeleton around the gripper fingers, particularly the additional concave layer on the gripping surface, allow softer contact and adaptive grasping of the objects, which greatly enhances the pull-out force in the longitudinal direction as shown in FIG. 23E. This adaptive gripping ability also reduces the precision requirement in width adjustments for gripping during operation without sensors and electronics, especially when handling fragile objects.

In some embodiments, this gripping mechanism has five degrees of freedom, one for controlling the width, and the rest of the four corresponding to each independently controlled tape spring structures. The four degrees of freedom from the tape loops allow four degrees of freedom of the grabbed object, including translation along the gripping fingers and rotation in the pitch and yaw axis, which are directly controllable, and rotation in roll axis, which is not directly controllable but achievable through a combination of pitch and yaw rotations as shown in FIGS. 25A-25E. By repeating this combination, the mechanism allows in-hand roll rotation without significantly altering the object's orientation. This capability is particularly useful in applications where drastic changes in object orientation are not desired, such as rolling an uncovered water cup around its axis while preventing spills, when the gripping direction is suboptimal.

The structural compliance provided by the tape springs facilitates the manipulation tasks of this mechanism in complicated environments, in which both the gripper and its surroundings are less likely to be damaged in case of collisions. The adaptive and soft grasping capabilities provided by the tape spring structure and the soft exoskeleton make this mechanism suitable for applications in handling delicate objects, particularly agricultural products. The ability of multi-axis continuous object manipulation can be applied in inspection tasks, where a camera can be fixed on the gripper to record the object's surface and detect possible flaws while the gripper continuously rotates the object in various axis, showing the entire surface to the camera.

The entire length of the tapes in this gripper can be used for manipulation tasks, allowing this gripper to handle multiple objects simultaneously. This characteristic allows the gripper to handle more objects at a time, increasing its efficiency, especially in pick-and-place tasks.

In some example embodiments, a gripper device includes two or more tape spring structures, each tape spring structure comprising at least one tape spring, wherein the tape spring structures each have at least one fold region where the tape spring structure is folded back on itself, and a plurality of drive actuators coupled to one of the two or more tape spring structures and configured to drive the tape spring structures such that a location of the fold region associated with each tape spring structure changes along a length of the tape spring structure or in space, wherein the two or more tape spring structures are arranged spaced apart from one another other to allow an object to be grasped therebetween, and wherein driving of the two or more tape spring structures enables a rotation or a translation of the object while the object remains grasped.

In some embodiments, each driving actuator comprises a motor and two or more rollers.

In some embodiments, a gripper device further includes a width adjustment mechanism configured to adjust a distance between the two or more tape spring structures.

In some embodiments, at least one of the tape spring structures comprises at least two tape springs coupled together along their outer edges to form an elongate hollow structure, except in the fold region, where the hollow structure collapses in on itself. In some embodiments, the at least two tape springs are encased in a low-friction sleeve that maintains contact between the outer edges of the tape springs while allowing them to slide relative to one another in a direction parallel to their lengths.

In some embodiments, the two or more tape spring structures each comprise at least one tape spring joined together at its ends to form a closed loop tape spring. In some embodiments, the two or more tape spring structures each comprise at least two loop tape springs laminated together such that the loop tape springs are concentric.

In some embodiments, the two or more tape spring structures each comprise a layer disposed on at least a portion of the tape spring structures configured to enhance friction between the tape spring structures and the object.

In some embodiments, the two or more tape spring structures each comprise an exoskeleton disposed over at least a portion of the tape spring structures, wherein the exoskeleton is configured to change shape to conform to a surface of the object.

In some embodiments, a gripper device includes two tape spring structures that are spaced apart from each other at a first distance. In other embodiments, a gripper device includes four tape spring structures, each spring structure being spaced apart from other three spring structures.

In some embodiments, each of the two or more tape spring structures are coupled to two drive actuators, and wherein driving of the two or more tape spring structures further enables extension and retraction of the two or more tape spring structures.

In some embodiments, a gripper device further includes two or more angular control beams, each coupled to an angular control actuator and to one of the two or more tape spring structures, wherein actuation of the angular control beam by the angular control actuator changes an orientation of a corresponding tape spring structure. In some further embodiments, a gripper device also includes two or more force sensors coupled to the two or more angular control beams and configured to measure a force applied to a corresponding tape spring structure when the tape spring structure is in contact with the object; and a force feedback controller configured to receive force measurements from the two or more force sensors, make a determination if the force measurement values exceed a pre-determined threshold, and cause actuation of the two or more tape spring structures based on the determination.

In some embodiments, the gripper device is coupled to a robotic arm.

In some embodiments, the gripper device does not require the use of an additional end-effector in order to grasp or manipulate objects.

In some embodiments, a method for grasping and manipulating an object includes grasping the object between two or more tape spring structures, each tape spring structure comprising at least one tape spring and having at least one fold region wherein the tape spring structure is folded back on itself, and driving at least one of the two or more tape spring structures such that a location of the fold region changes along a length of the tape spring structure or in space to rotate or translate the object while maintaining the grasp on the object.

In some embodiments, driving at least one of the two or more tape spring structures comprises driving a first tape spring structure and a second tape spring structure in opposite directions to rotate the object about an axis.

In some further embodiments, driving at least one of the two or more tape spring structures comprises driving a first tape spring structure and a second tape spring structure in a same direction to translate the object along a length of the tape spring structures.

In some embodiments, the method further includes grasping the object between four tape spring structures; and independently controlling driving of each of the four tape spring structures to rotate the object about multiple axes.

In some embodiments, the method further includes deforming at least one of the two or more tape spring structures against a surface to grasp a flexible material resting on the surface; and driving the at least one of the two or more tape spring structures to pull the flexible material into the grasp.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A gripper device, comprising:
two or more tape spring structures, each tape spring structure comprising at least one tape spring, wherein the tape spring structures each have at least one fold region where the tape spring structure is folded back on itself; and
a plurality of drive actuators, each coupled to one of the two or more tape spring structures and configured to drive the tape spring structures such that a location of the fold region associated with each tape spring structure changes along a length of the tape spring structure or in space,
wherein the two or more tape spring structures are arranged spaced apart from one another other to allow an object to be grasped therebetween, and
wherein driving of the two or more tape spring structures enables a rotation or a translation of the object while the object remains grasped.

2. The gripper device of claim 1, wherein each driving actuator comprises a motor and two or more rollers.

3. The gripper device of claim 1, further comprising a width adjustment mechanism configured to adjust a distance between the two or more tape spring structures.

4. The gripper device of claim 1, wherein at least one of the tape spring structures comprises at least two tape springs coupled together along their outer edges to form an elongate hollow structure, except in the fold region, where the hollow structure collapses in on itself.

5. The gripper device of claim 4, wherein the at least two tape springs are encased in a low-friction sleeve that maintains contact between the outer edges of the tape springs while allowing them to slide relative to one another in a direction parallel to their lengths.

6. The gripper device of claim 1, wherein the two or more tape spring structures each comprise at least one tape spring joined together at its ends to form a closed loop tape spring.

7. The gripper device of claim 6, wherein the two or more tape spring structures each comprise at least two loop tape springs laminated together such that the loop tape springs are concentric with one another.

8. The gripper device of claim 1, wherein the two or more tape spring structures each comprise a layer disposed on at least a portion of the tape spring structures configured to enhance friction between the tape spring structures and the object.

9. The gripper device of claim 1, wherein the two or more tape spring structures each comprise an exoskeleton disposed over at least a portion of the tape spring structures, wherein the exoskeleton is configured to change shape to conform to a surface of the object.

10. The gripper device of claim 1, comprising two tape spring structures that are spaced apart from each other at a first distance.

11. The gripper device of claim 1, comprising four tape spring structures, each spring structure being spaced apart from other three spring structures.

12. The gripper device of claim 1, wherein each of the two or more tape spring structures are coupled to two drive actuators, and wherein driving of the two or more tape spring structures further enables extension and retraction of the two or more tape spring structures.

13. The gripper device of claim 1, further comprising two or more angular control beams, each coupled to an angular control actuator and to one of the two or more tape spring structures, wherein actuation of the angular control beam by the angular control actuator changes an orientation of a corresponding tape spring structure.

14. The gripper device of claim 13, further comprising:
two or more force sensors coupled to the two or more angular control beams and configured to measure a force applied to a corresponding tape spring structure when the tape spring structure is in contact with the object; and
a force feedback controller configured to receive force measurements from the two or more force sensors, make a determination if the force measurement values exceed a pre-determined threshold, and cause actuation of the two or more tape spring structures based on the determination.

15. The gripper device of claim 1, wherein the gripper device is coupled to a robotic arm.

16. A method for grasping and manipulating an object, comprising:
grasping the object between two or more tape spring structures, each tape spring structure comprising at least one tape spring and having at least one fold region wherein the tape spring structure is folded back on itself, and
driving at least one of the two or more tape spring structures such that a location of the fold region changes along a length of the tape spring structure or in space to rotate or translate the object while maintaining the grasp on the object.

17. The method of claim 16, wherein driving at least one of the two or more tape spring structures comprises driving a first tape spring structure and a second tape spring structure in opposite directions to rotate the object about an axis.

18. The method of claim 16, wherein driving at least one of the two or more tape spring structures comprises driving a first tape spring structure and a second tape spring structure in a same direction to translate the object along a length of the tape spring structures.

19. The method of claim 16, further comprising:
grasping the object between four tape spring structures; and
independently controlling driving of each of the four tape spring structures to rotate the object about multiple axes.

20. The method of claim 16, further comprising:
deforming at least one of the two or more tape spring structures against a surface to grasp a flexible material resting on the surface; and
driving the at least one of the two or more tape spring structures to pull the flexible material into the grasp.
